(19) United States
(12) Patent Application Publication
(10) Pub. No.: US 2014/0122352 A1
(43) Pub. Date: May 1, 2014

(54) METHOD AND SYSTEM FOR REPORTING HUNTING HARVESTS TO REPORTING AGENCY

(71) Applicants: GARRETT WILLIAM GLEIM, GAINESVILLE, FL (US); NATHANIEL DONALD NADEAU, GAINESVILLE, FL (US)

(72) Inventors: GARRETT WILLIAM GLEIM, GAINESVILLE, FL (US); NATHANIEL DONALD NADEAU, GAINESVILLE, FL (US)

(21) Appl. No.: 14/069,129

(22) Filed: Oct. 31, 2013

Related U.S. Application Data
(60) Provisional application No. 61/720,516, filed on Oct. 31, 2012.
(60) Provisional application No. 61/720,543, filed on Oct. 31, 2012.

(51) Int. Cl. G06Q 30/00

(52) U.S. Cl. CPC G06Q 30/018
USPC 705/317

(57) ABSTRACT

Embodiments of the invention relate to a method and system for allowing a hunter to report a hunting harvest by taking an image of the harvest. A specific embodiment also uploads the image to a social media platform. An application, or app, on a smartphone can allow hunters to upload an image, or photo, of the harvested animal, such as a deer, and initiate a report to the reporting agency that may or may not include the photo of the animal as evidence of their harvest for reporting agency purposes. Embodiments of the invention relate to a method and system to share information regarding the timing and/or location of an animal rut. Such embodiments can be used in conjunction with the embodiments of the invention relate to a method and system for allowing a hunter to report a hunting harvest by taking an image of the harvest.

### CROSS-REFERENCE TO RELATED APPLICATIONS

The present application claims the benefit of U.S. Provisional Application Ser. No. 61/720,516, filed Oct. 31, 2012, and U.S. Provisional Application Ser. No. 61/720,543, filed Oct. 31, 2012, both which are hereby incorporated by reference herein in their entirety, including any figures, tables, or drawings.

### BACKGROUND OF INVENTION

Hunters are typically required to report hunting harvests to one or more reporting agencies. Reporting the harvests can be accomplished by the hunter calling the reporting agency, visiting a web page, or visiting a deer check station, to report the deer harvest to the appropriate reporting agency. There are also web forms that allow a hunter to enter a tag number and report the harvest. Further, some reporting agencies may allow submission of a photo, or image, of the deer, or other harvest, as evidence of the harvest. Such actions can be time consuming and/or tedious.

Many hunters also take photos of their deer harvests, or other harvests, to share with others and/or to create a memento. Some hunters may even wish to upload such a photo to storage and/or a social media site to share with others.

A deer rut, or the rut of any another animal, is a term used to describe the mating season of the deer, or other animal. During the rut, deer will display certain behaviors, such as rubbing trees, which serve as scent sign posts for olfactory and/or visual communication. Deer may be easier for hunters to harvest during rut. Therefore, knowing when rut begins, or when it is rut, and where the deer are rubbing during rut, can assist a hunter in harvesting the deer. It is difficult to know when the deer rut, or the rut of any animal, begins. As an example, deer at one location may be in rut, while deer a few miles away may not yet be in rut.

Hunt N Map™ is a software program that provides hunters the ability to write notes or journals and log the topographical area they hunt in. This software provides hunters topographical maps, but does not offer a system to allow communications with other hunters regarding the rut or deer movement.

Deer Tracker™ from C&E Outdoors™ provides a journal software program, but does not offer a system to allow communications with other hunters regarding the rut or deer movement.

Journal app™ for the iPhone™ provides a hunting log, but does not a system to allow communications with other hunters regarding the rut or deer movement.

Accordingly, it would be advantageous to provide a method and system to allow hunters to report their harvests, such as deer harvests or turkey harvests, to the appropriate reporting agency, at the same time a photo is taken for the purpose of sharing with others and/or creating a memento. The photo can then also, optionally, be uploaded to a storage and/or social media site.

Accordingly, there is a need for a method and system where hunters can communicate and alert one another as to where and/or when they suspect rut occurred, is occurring, or will occur.

### BRIEF SUMMARY

Embodiments of the invention relate to a method and system for allowing a hunter to report a hunting harvest by taking an image of the harvest. A specific embodiment also uploads the image to a social media platform. A specific embodiment is implemented via a smart phone application, augmented reality glasses, or other apparatus, that enables users to upload photos to share with friends, while also fulfilling reporting agency requirements. An application, or app, on a smartphone can allow hunters to upload an image, or photo, of the harvested animal, such as a deer, and initiate a report to the reporting agency that may or may not include the photo of the animal as evidence of their harvest for reporting agency purposes.

The reporting agency, or state, can issue hunting permits that have a QR code or a unique ID number. This unique ID number can be entered into the social network system, or other software/hardware platform, and the social network system can download the permit, or tag, information from the state directly. When a hunter harvests an animal, such as a deer, the hunter can connect the picture of the harvest to a tag. In an embodiment, when the hunter posts the picture on the social media system, a harvest report can be initiated and transmitted to the reporting agency, and the picture can, optionally, be incorporated with a harvest report that is forwarded to the state, or other reporting agency. Reporting this way, a harvest report can be submitted for a given license, in a manner that is simpler and more efficient for the hunter, and more efficient for the state agency.

Embodiments of the subject invention are compatible with various species of antlered animals, such as the whitetail deer, mule deer, elk, red stag or red deer, reindeer, fallow deer, moose, axis deer or chital, sable, kudu, impala, Cape buffalo, gazelle, lechwe, bushback, eland, gemsbok, nyala, American buffalo, harte beast, wilde beast, roan antelope, waterbuck, puku, and/or blacktail deer. The mention of any particular species as a harvest is provided for illustrative purposes only and is not intended to limit the scope of the application.

Embodiments of the invention relate to a method and system to share information regarding the timing and/or location of an animal rut. Embodiments of the invention relate to a social media platform for a group of hunters to use to allow one or more hunters, or spotters, to inform other hunters, or members, of information regarding the rut of an animal, such as deer rut. Other animals that rut include, but are not necessarily limited to, sheep, elk, moose, caribou, ibex, goats, pronghorn, and antelope. The system can then process the information provided and accomplish one or more of the following: post the information on a website or otherwise make the information provided available, provide predictions regarding the location and/or timing of the rut, provide an indication of whether any thresholds or other criteria have been met which has been determined to be an indication of past, present, or future rut, and send out alerts and/or messages regarding the received information. In an embodiment, based on activities reported, increases in rutting activities, or other changes in rutting activities, can be analyzed to determine whether rutting is occurring, is about to occur, is no longer occurring, and/or is about to stop. In a specific embodiment, a determination is made that rutting is occurring when a certain threshold of rutting activities is reported and/or a certain increase in reporting or rutting activity is above a certain threshold. Specific embodiments can mine data available from one or more sources, and optionally aggregate some or all of the data and process the data to provide insights as to when the rut begins and ends. FIGS. 46 and 47 show graphs that show how such data can be mined and used to calculate and/or determine a rut from one or more sources of geographical data. Determination of rut timing can be made for a variety of geographical areas, which can be contiguous, separate, overlapping, etc.

Specific embodiments of the system allow members to set their smartphones, augmented reality glasses or other devices, to alert them of when people post messages relating to the rut, such as messages relating to rut within a certain distance of their selected location and/or within a certain time period of their selected time period. Other criteria can also be used to trigger the sending of alerts, such as a certain number of reports, two or more reports within a certain distance of each other, reports by a trusted hunter, and reports by a hunter identified by the party requesting the alert. These alerts can keep hunters better informed of when and/or where rut is occurring, which can allow them to hunt in locations and times that increase their chances of making a harvest.

FIGS. 4-7 show the display of a mobile phone utilized in an embodiment of a Mobile App that allows users to send in reports providing information regarding what they have observed in one or more hunting regions. These reports are analyzed by the system, e.g., via software system servers or software on servers in the cloud, to identify ruts for specific locations and/or for a given timeframe. The system can then send out reports providing these findings to interested users. Further embodiments can involve sending data, which can be mimed from available sources or otherwise obtained, to the user's smartphone, augmented reality glasses or other devices, and the data can be processed on the device in a manner controlled by the user, or preset, to provide information to the user regarding rut timing.

An embodiment incorporates an application for a smartphone that allows hunters to use the GPS function, or manually enter in their physical location, and upload pictures, messages, or alerts, regarding their observations in the hunting area, such as when they see movement that suggests rut. Specific embodiments involve images that automatically have a time, date and/or GPS stamp embedded or associated with the image such that the hunter does not have to report same. These pictures, messages, and/or alerts can be uploaded to, for example, a dedicated server or a central cloud. The information regarding animal sightings, animal movements, markings on trees or shrubs left by animals, indications of animal movements and/or presence in certain areas, and other indicators of rut can then be processed to identify movements of deer in rut, location(s) of rut, and/or timing of rut and/or by determining to identify, for example, his picture trend. This information can then be disseminated to people who are interested.

### BRIEF DESCRIPTION OF DRAWINGS

FIG. 1 shows a schematic of a system in accordance with an embodiment of the subject invention.

FIG. 2 shows a schematic of a system for inputting, processing, and disseminating information regarding rut for one or more animals, such as deer, in accordance with an embodiment of the subject invention.

FIG. 3 shows an embodiment that incorporates harvest reporting and determination of rut timing.

FIGS. 4-7 show the display of a mobile phone showing various screen shots relating to a mobile application in accordance with an embodiment of the subject invention.

FIGS. 8-43 show images 1-36, respectively.

FIGS. 44 and 45 show charts of animals to which those embodiments of the invention can be applied.

FIGS. 46 and 47 show graphs of expected animal sightings, which can be utilized in accordance with the invention.

### DETAILED DISCLOSURE

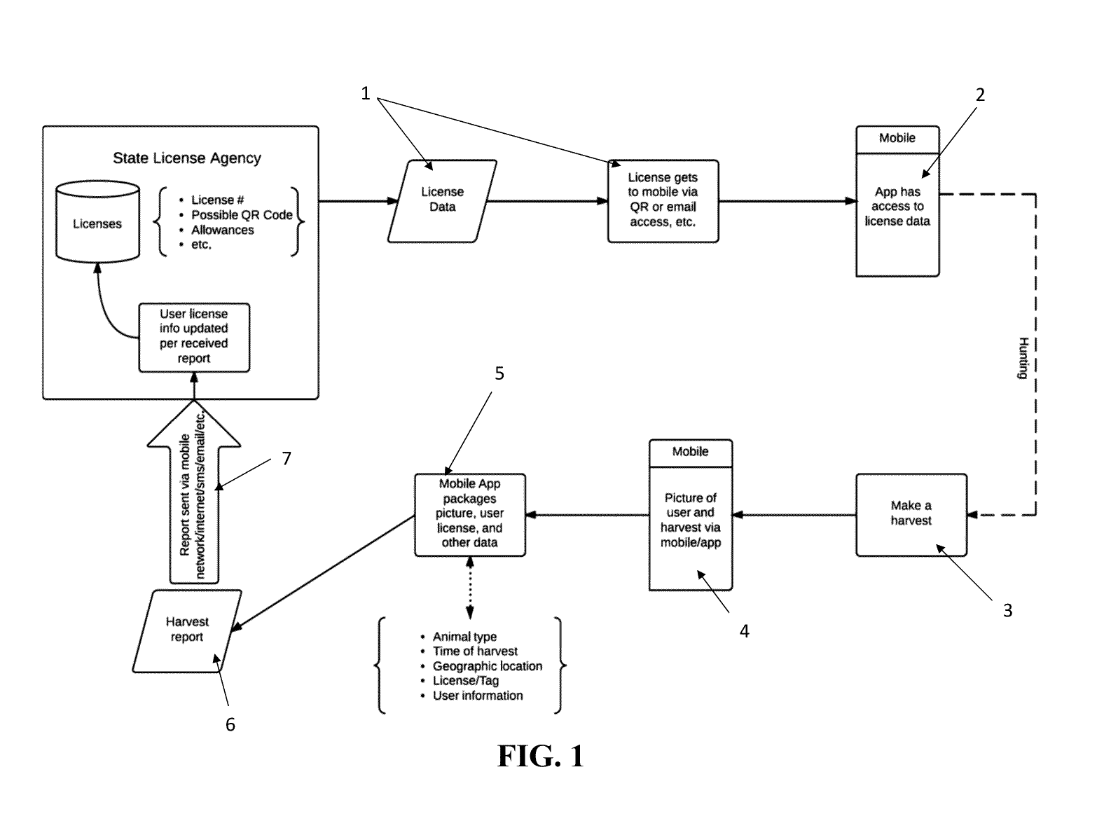

Embodiments of the invention relate to a mobile application, smart phone application, augmented reality glasses application, and/or other device application, that allows hunters to more conveniently report their harvests to a state agency or other reporting entity, where the accuracy of the reports can be enhanced, such as by adding a date, time, GPS location stamp, and/or other information, and the reports can be submitted more efficiently than the current reporting methods. FIG. 1 shows a schematic of a specific embodiment, where the mobile application acquires the hunter's license data from the state license agency through the use of, for example, a Quick Response code (QR), license number, allowance, ID number 1, and/or other information. As an example, the state license agency can issue hunting permits with either a QR code or ID number, which the system stores and/or accesses as needed. The system, via for example a smart phone is then able to use this information to download the license data directly from the State License Agency and connect the mobile application with the owner's license data 2.

Once a hunter that is connected to the system, such as a social media platform, makes a harvest 3, the hunter can upload a picture of themselves along with their harvest onto the social media platform via the mobile application 4 and the mobile phone. In this way, the photo can be shared on the social media site, such as with the hunter's friends, the mobile application can extract information from the picture and, along with the information in the system or gathered by the system from the reporting agency, package this information into a harvest report 6. In an embodiment, the size and/or age of the deer can be determined from the photo of the deer, for example from the size of the eye of the deer or from the size of the deer's antlers. This harvest report can comprise of the hunter's license data along with information concerning the harvest, such as the animal type, time of harvest, weapon(s) used, ammunition type, geographical location, size of the animal's herd, devices or techniques to lure the animal such as type(s) of animal call used or type of feed and/or feeder, or other data 5. This information concerning the harvest can come from the picture itself, with each photograph having a time stamp and preferably a GPS location stamp, or can be entered by the hunter. In an embodiment, facial recognition software, and/or other types of software, can be utilized to measure the size and type of the harvest. Further, facial recognition can be utilized to confirm who is in the picture, whether the hunter who is licensed is in the picture, and/or other information regarding who is or is not in the picture. This can be used to provide an indication of whether the harvest is the licensed hunter's harvest that the report indicates.

Once all of the desired information is gathered, the mobile application can then send the harvest report to the state license agency 7. The state license agency can then upload this data onto their system, thus eliminating the need for the hunter to visit a website, stop at a check station, or call to report their harvest.

An advantage of the system is that more data can be reported and, potentially, more honest data can be reported to the state agencies. Each photo can have a time stamp. The photo can also, optionally, have a GPS location stamp. This allows the system to inform the state agency where the picture was taken, which is often near where the deer was harvested. Moreover, the hunter can be in the picture, so as to help validate the hunter actually harvested the deer, rather than letting a friend use the hunter's deer tag.

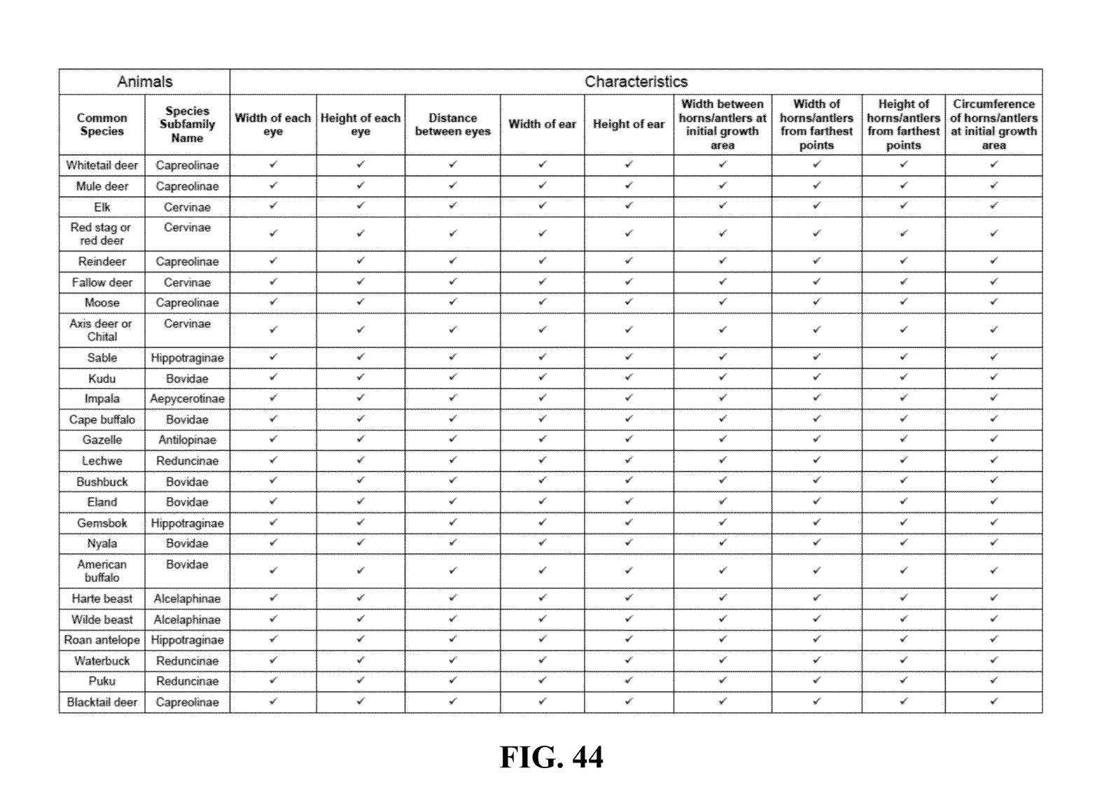

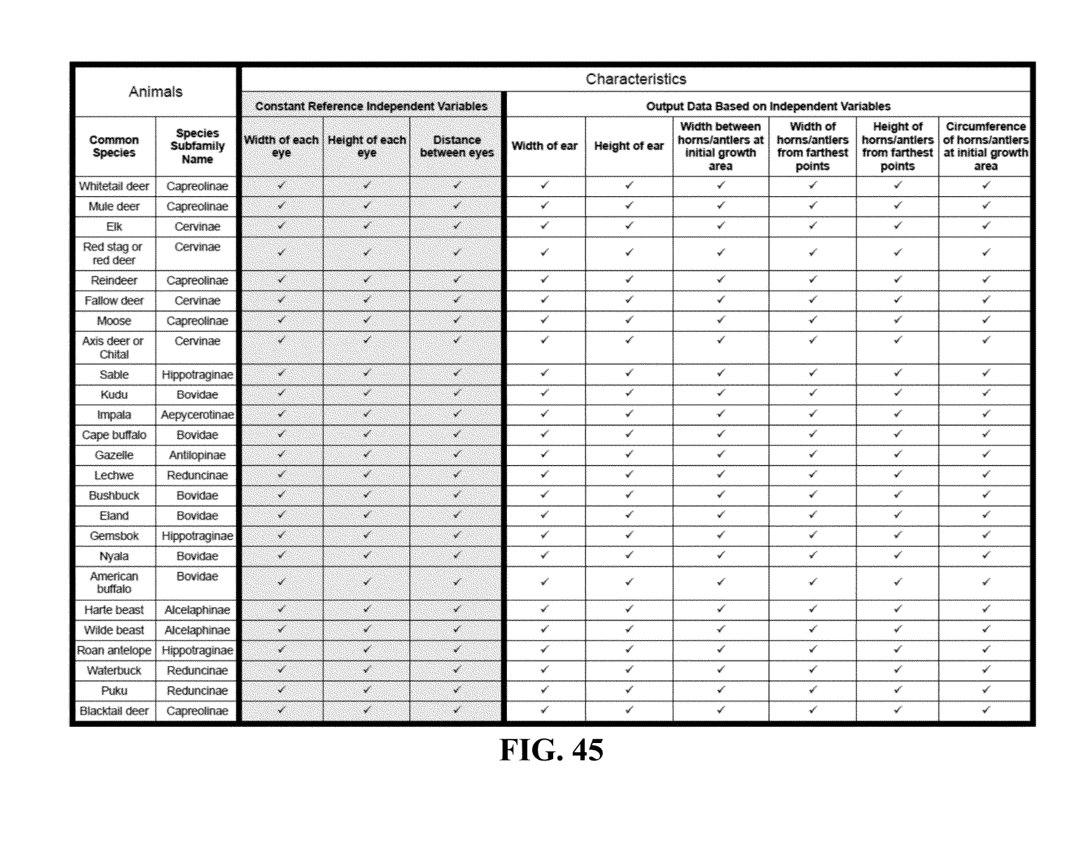

In a specific embodiment, facial recognition software can measure the features of the hunter's face to identify the hunter. Additional software can be used to measure the size of the deer, e.g., estimate the size of the deer and/or the size of the deer's horns based on the size of the eyes of the deer in the photo. Facial software or other software can be used to measure the size of a face, an eye, or other feature of a person, such as the hunter, in the photo. This is because the software can assume the human eye is about the same size from birth until full adult and the size of each human's eye can be assumed to be the same or specific people can share the size of the eye in the system. Based upon this constant (eye size), the software can measure one or more other aspects in the picture, such as the antlers or horns of the animal besides the human. The eyes and/or ears of an antelope or deer, or other animal, can also be used. Depending on the species, not only are the eyes a constant, but also the ears are a constant. In this case, the antlers or horns can be sized using the size of the eye and/or ear of an animal in the photo or other animal part. FIGS. 44 and 45 list features that provide constant references. Further, embodiments, can use the gun, or other object (such as the sun or logo on a hat or other item of clothing provided by the system operator) in the photo to determine the size of the animal or animal features (horns, etc.) by knowing the size of a gun in the photo based on software recognition of the gun model, or information provided by the hunter regarding the gun size or make (e.g., a database can store such dimensions). Therefore, many details can be provided to the state that is not normally provided to a state when someone calls a deer harvest registration phone line. In a further embodiment, additional software can perform antler scoring, or counting of the number of “points” per antler, thereby generating as additional data a point count number. The point count can be uploaded and shared similarly to the other data, e.g. uploading to the proper governmental agency, to a social network, and/or sent via text message, email, and/or voicemail.

Although the preferred embodiment utilizes a smart phone or tablet to take an image of a harvest and upload the image to a system that submits the image of the harvest with a harvest report to a reporting agency, other embodiments can allow for other actions alone or in conjunction with the actions enabled in the preferred embodiment. As an example, a hunter can use a smart phone to create a harvest report without an image. Further embodiments can utilize wearable apparatus for image taking and/or communicating such as Google glass or other augmented reality glasses or wearable device. In an embodiment, the smart phone app can prompt the hunter to enter information for creation of the report, such as location, size of deer, and time of kill. In other embodiments, an image and/or other information can be uploaded from a variety of devices, such as a laptop or a desktop computer, a device capable of sending a text message, an email, or a voicemail, or entering responses to an automated voice system, and a report can be prepared and submitted utilizing some or all of the image, and/or other information provided. In this way, the image can be taken with a digital camera, uploaded to a computer or other device, and then transferred to the system for inclusion in the report.

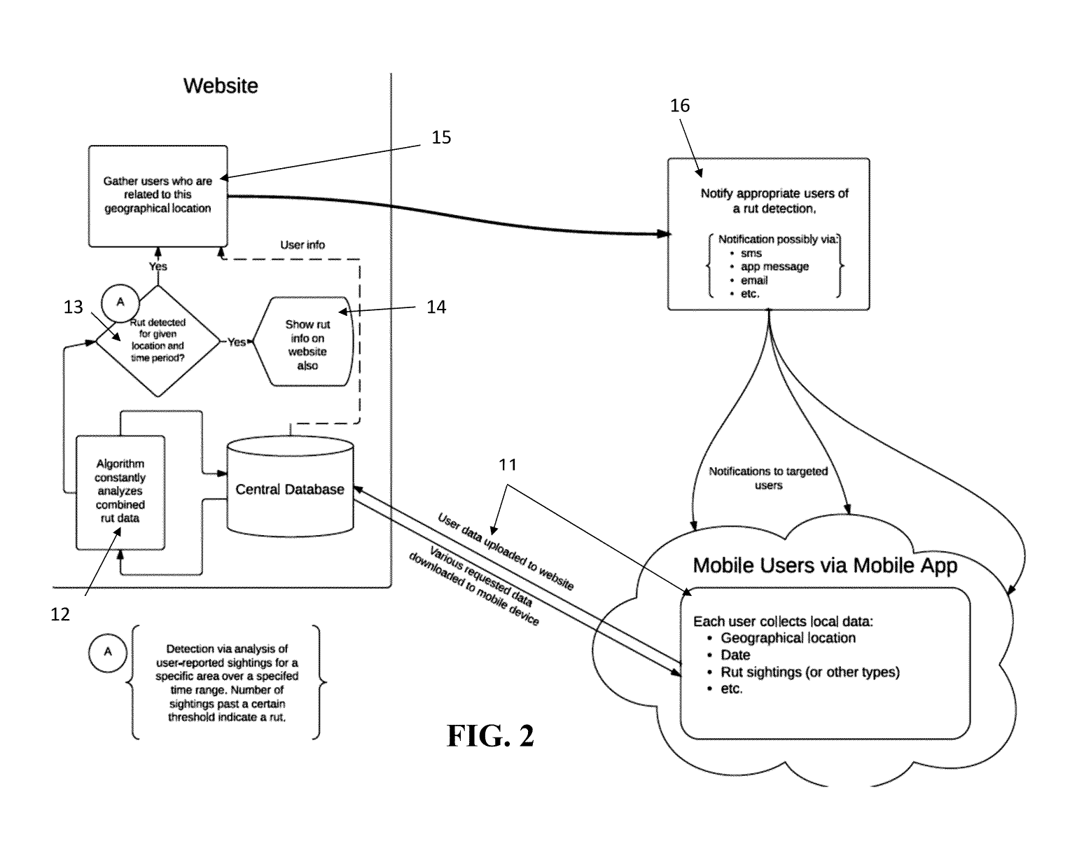

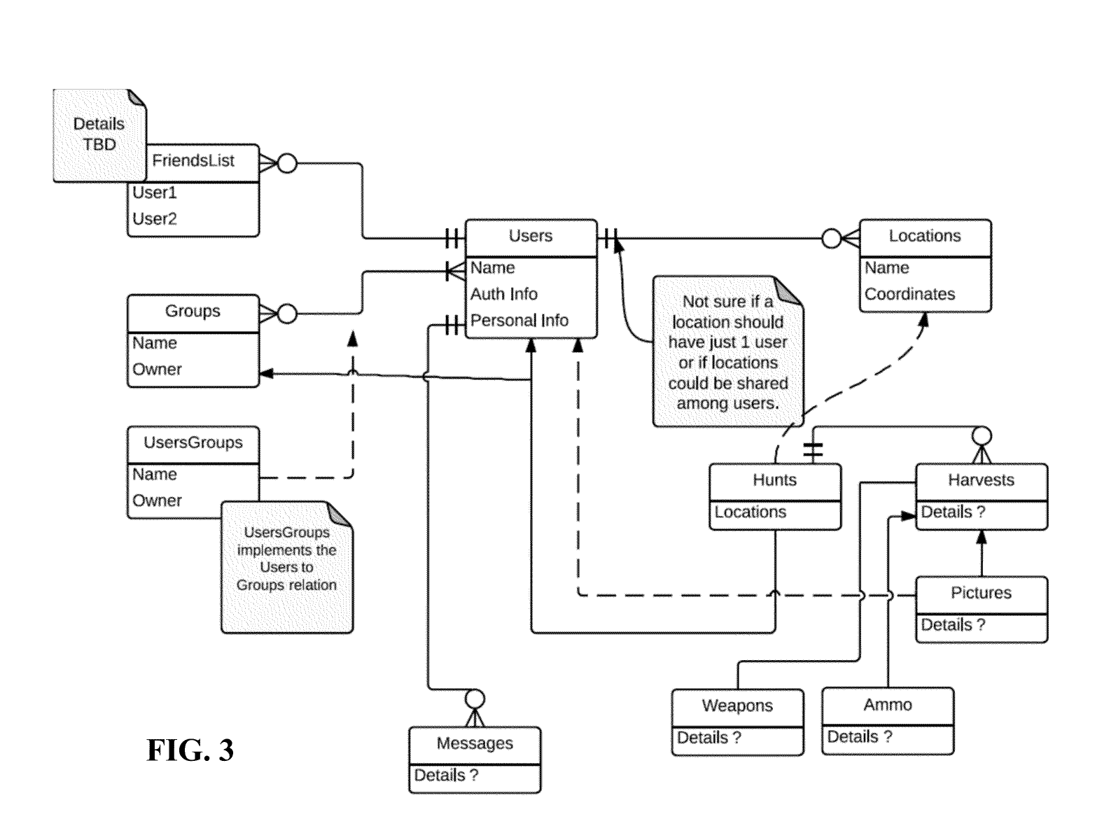

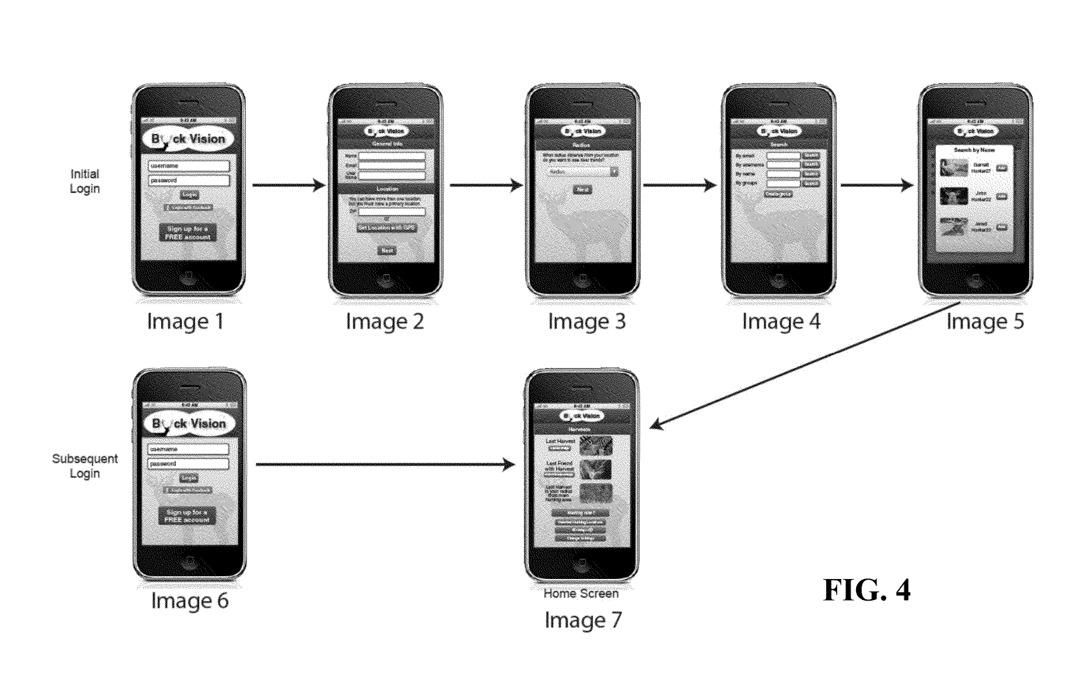

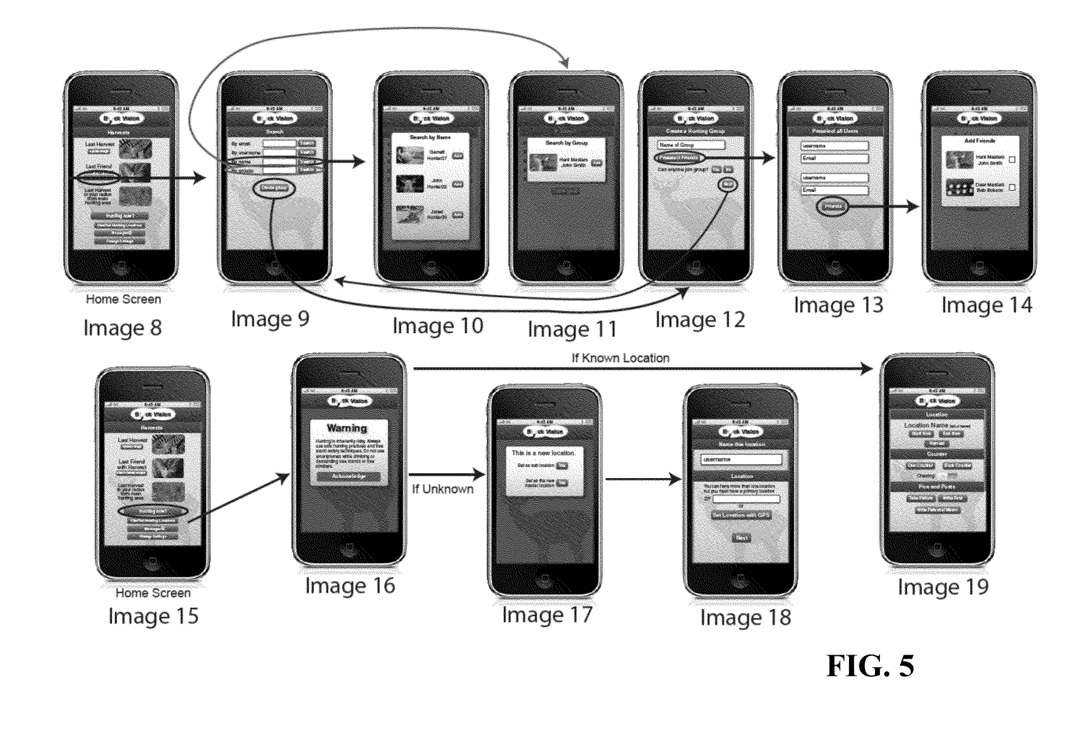

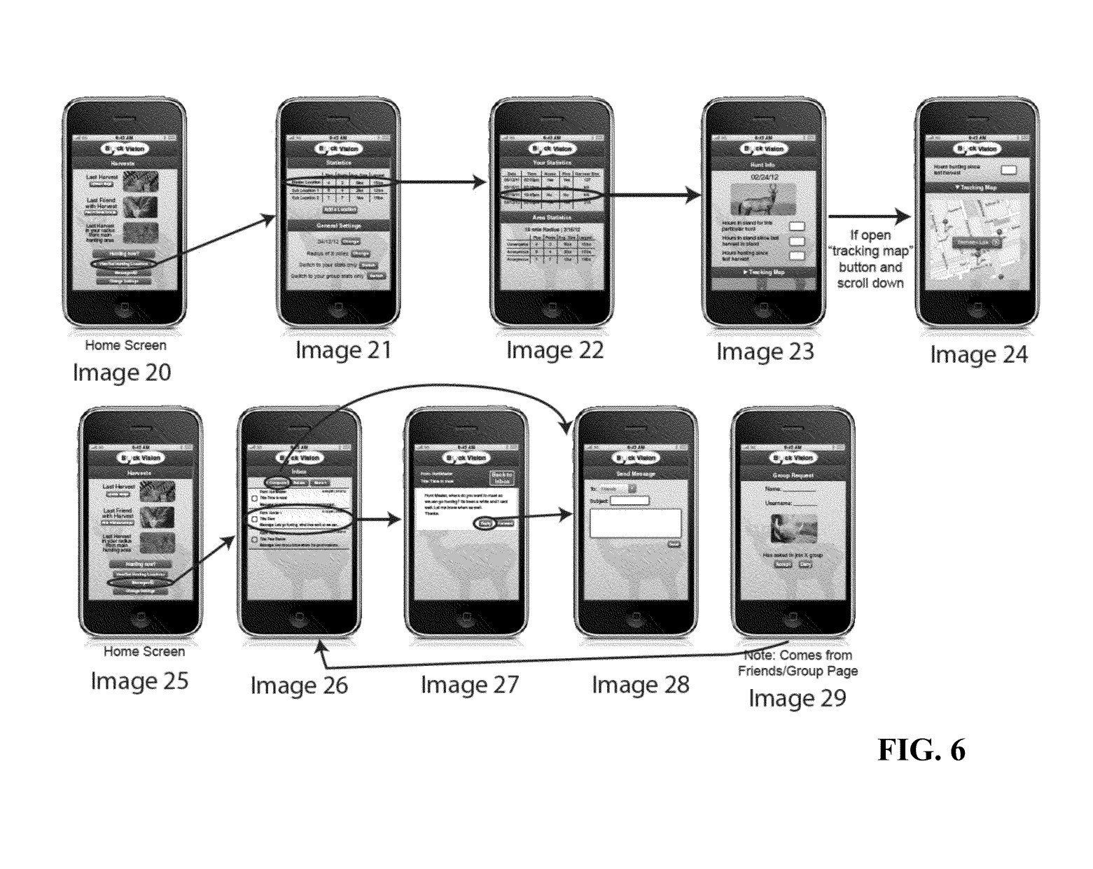

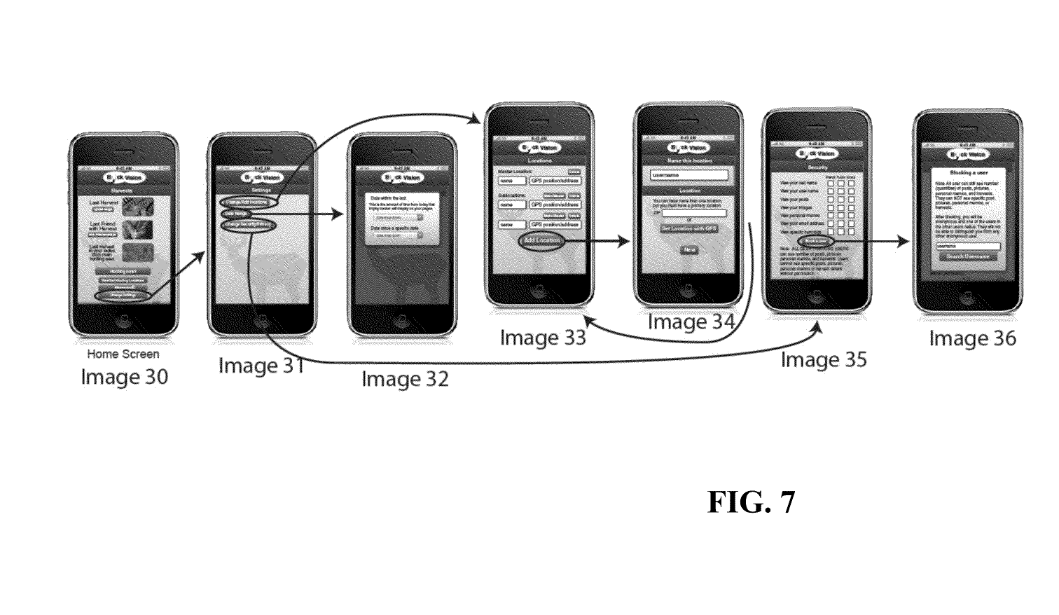

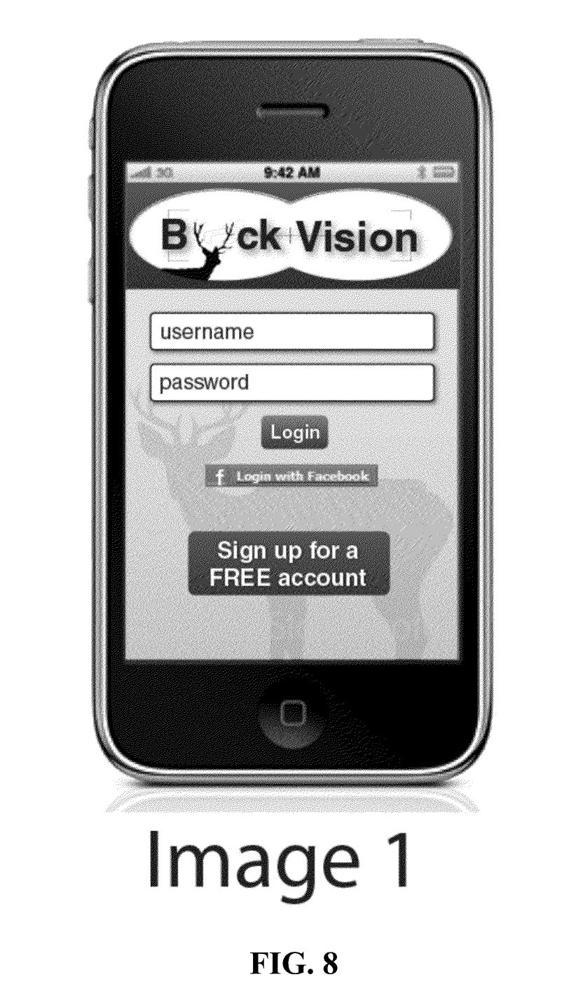

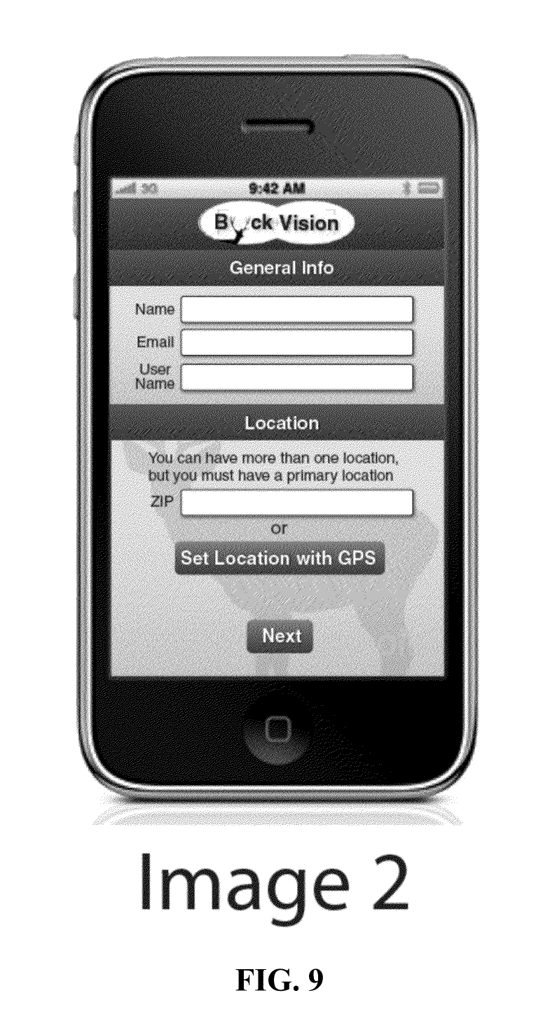

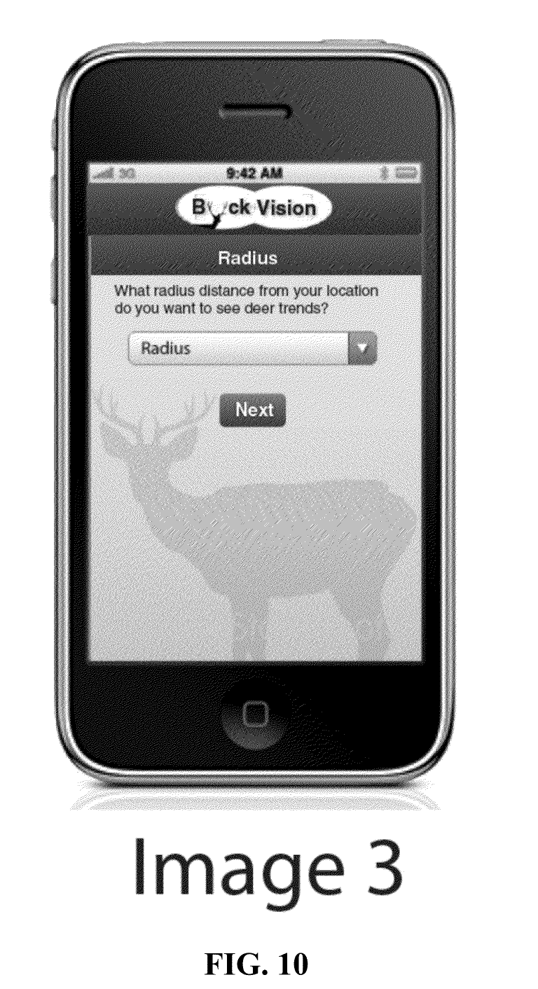

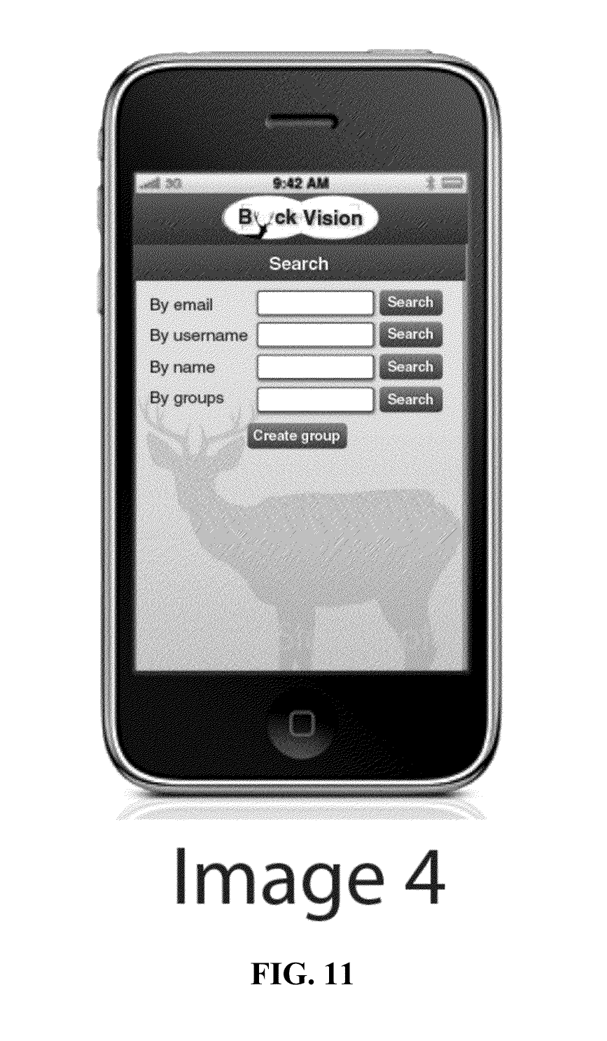

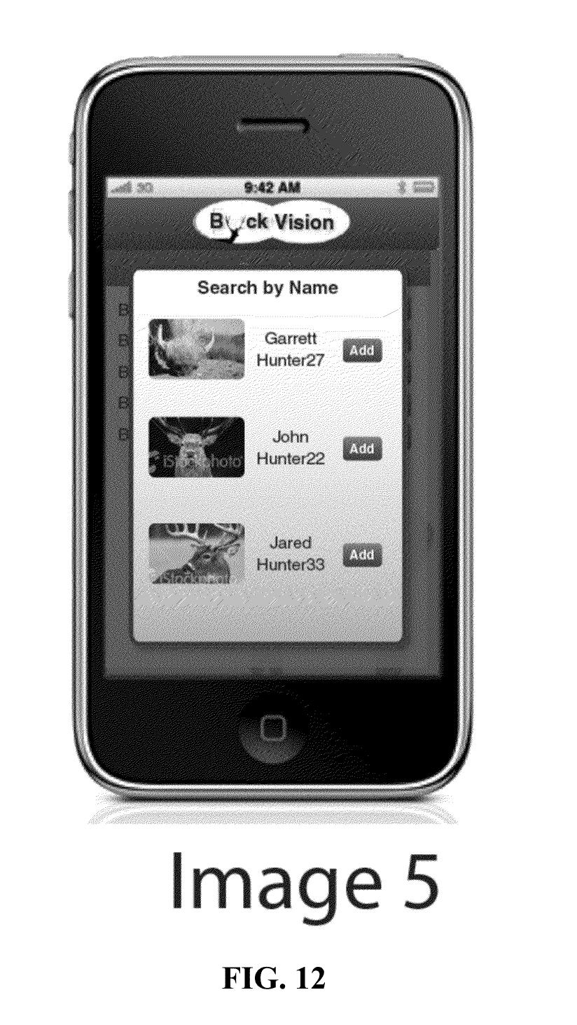

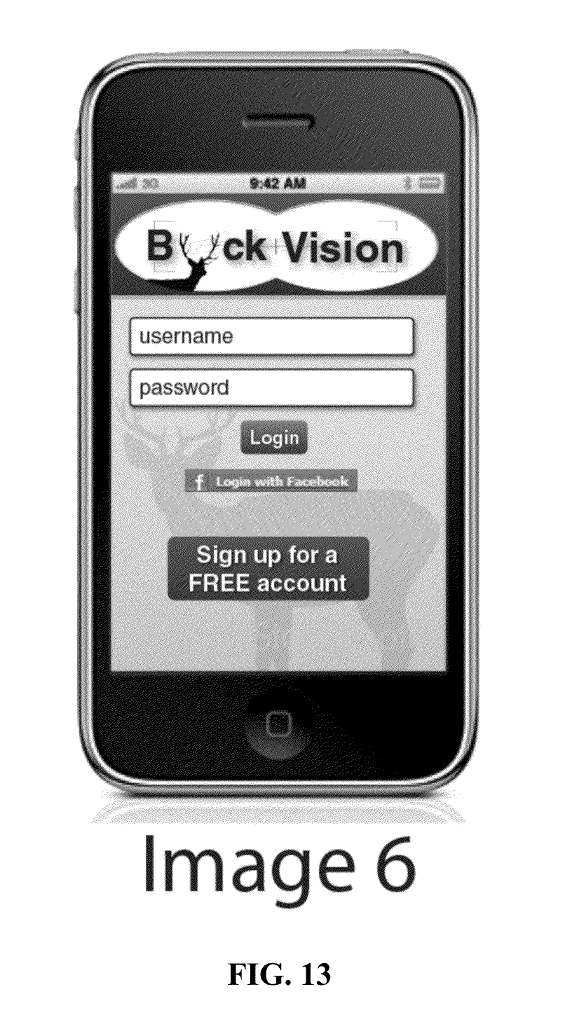

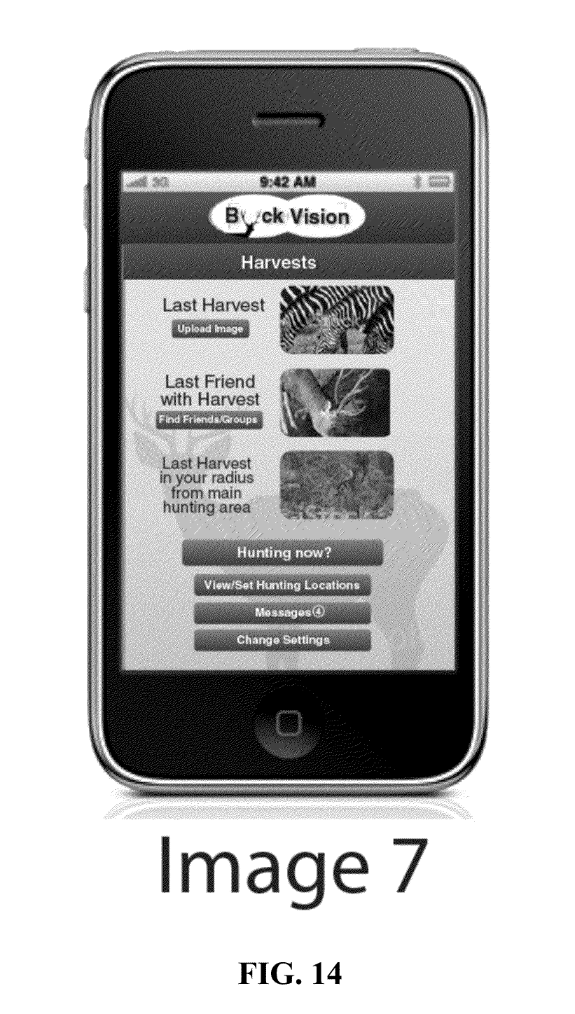

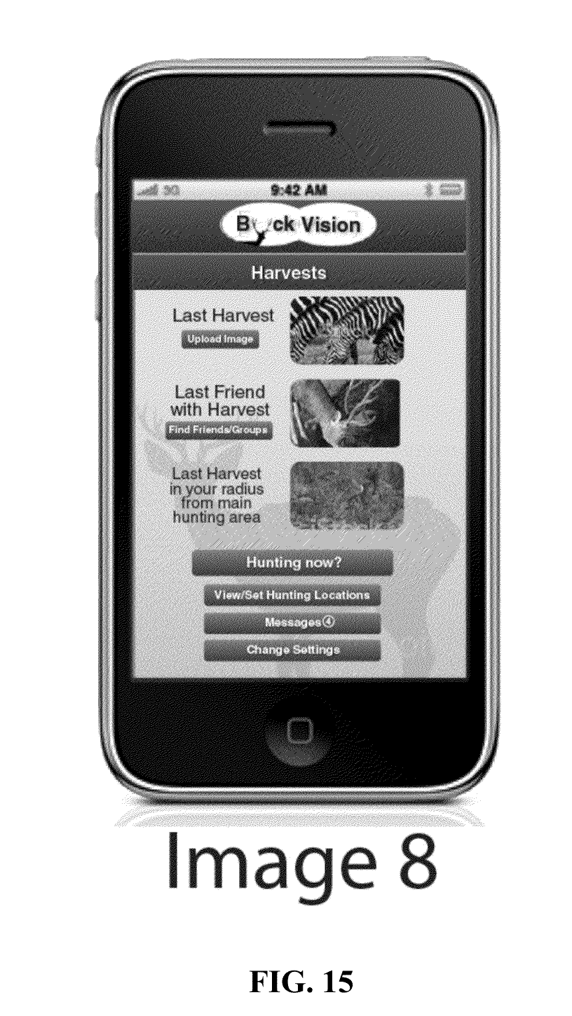

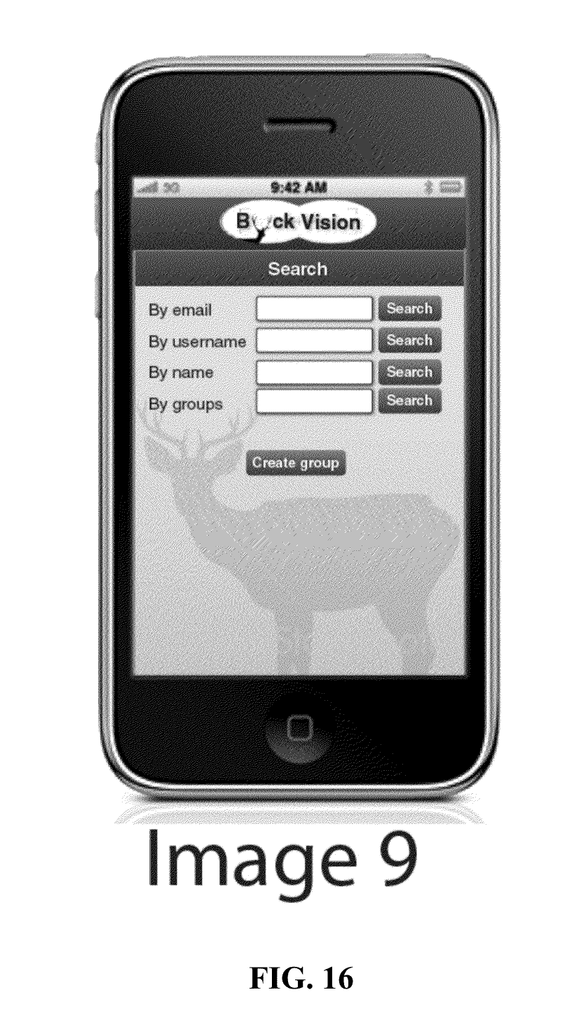

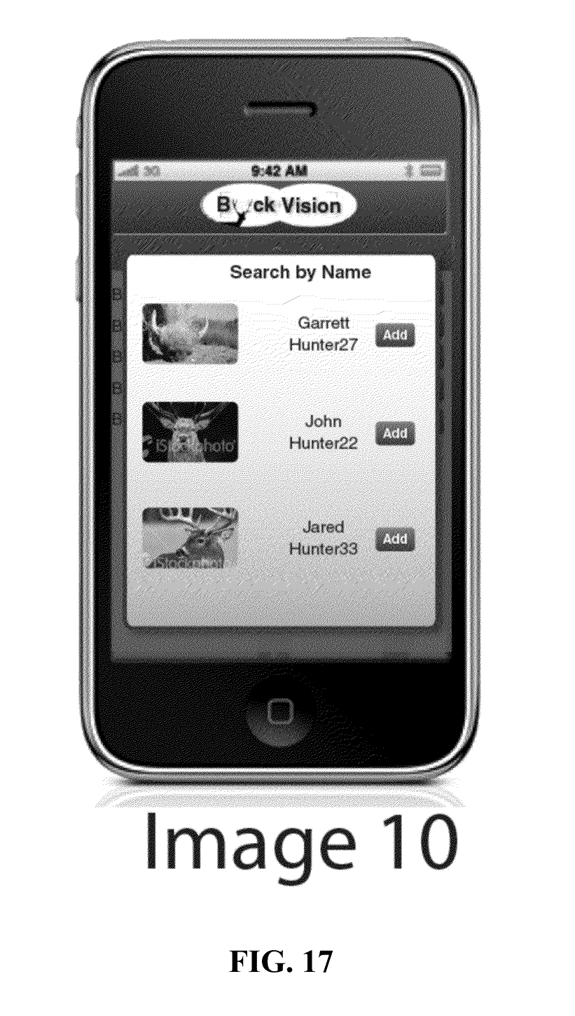

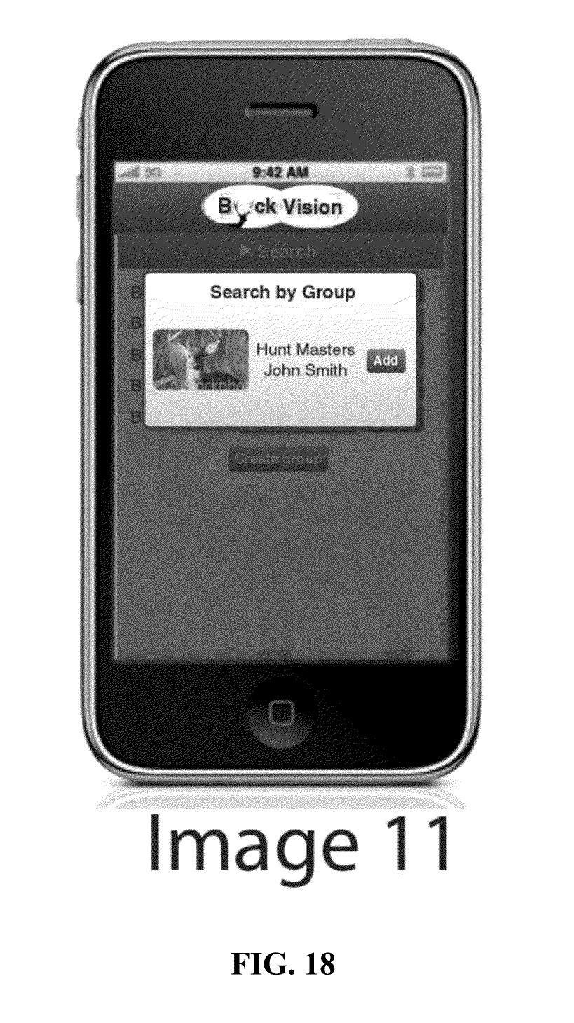

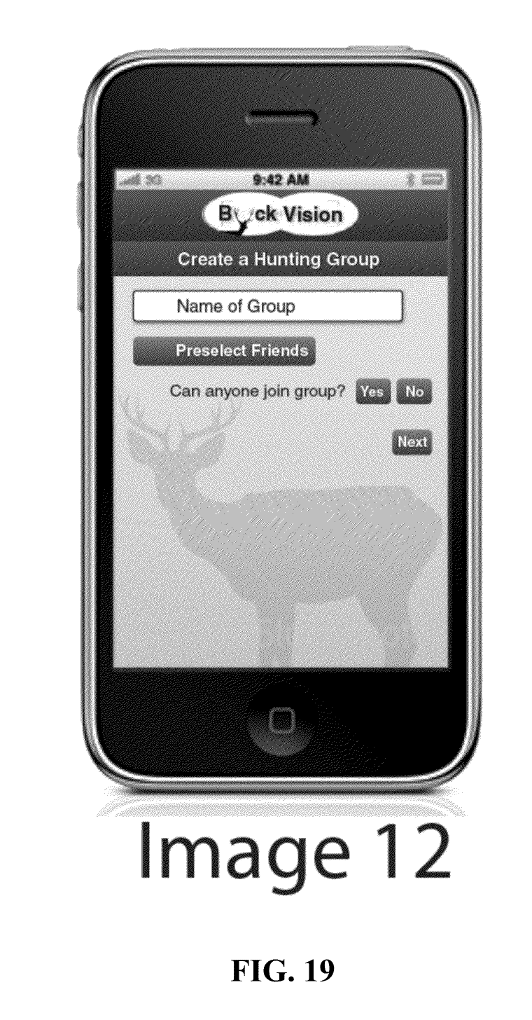

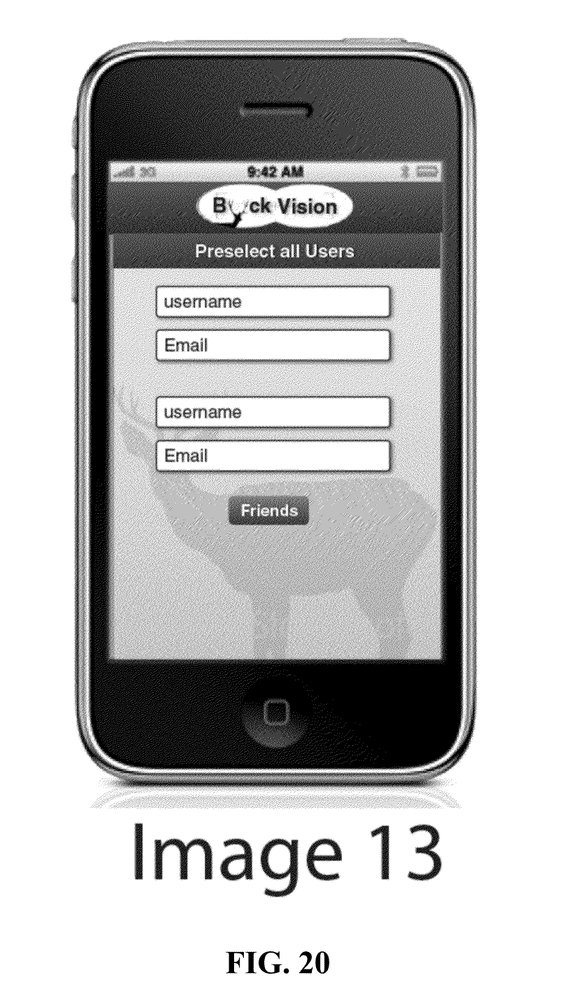

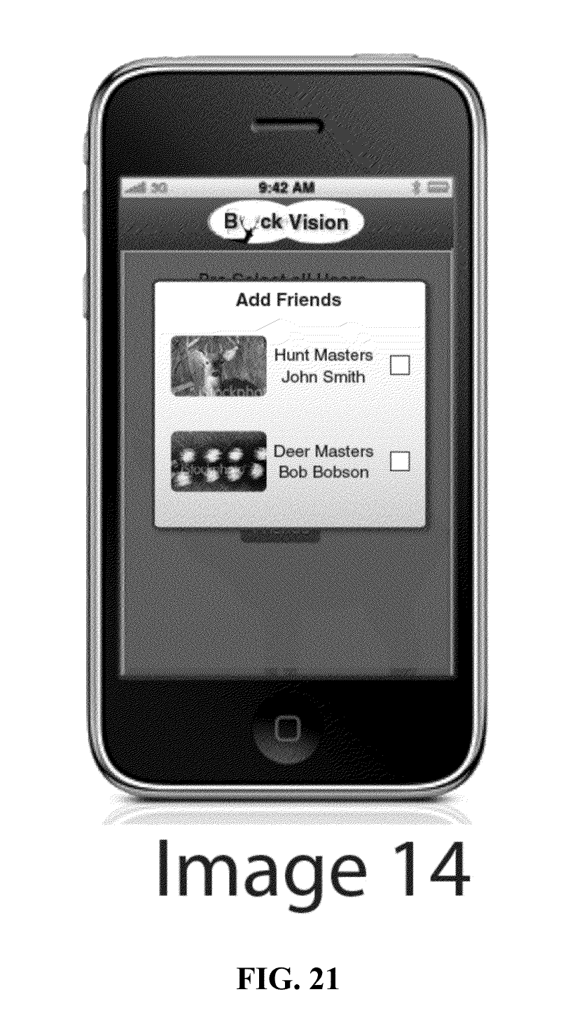

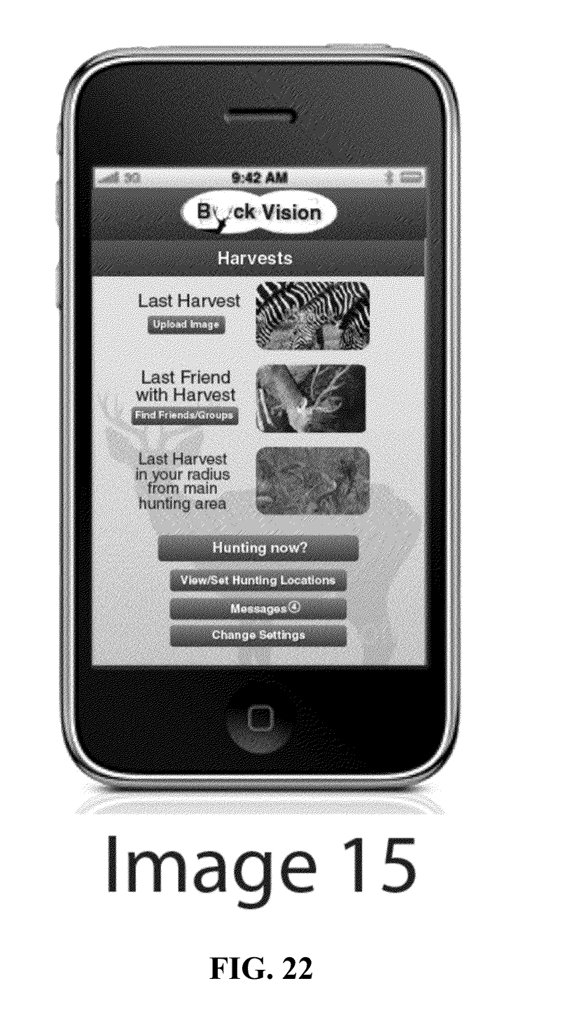

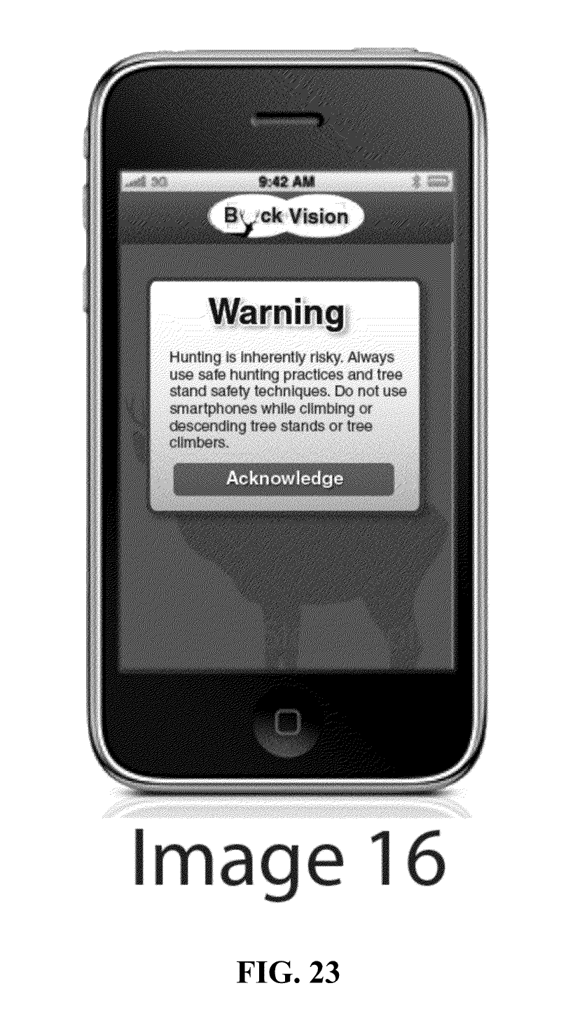

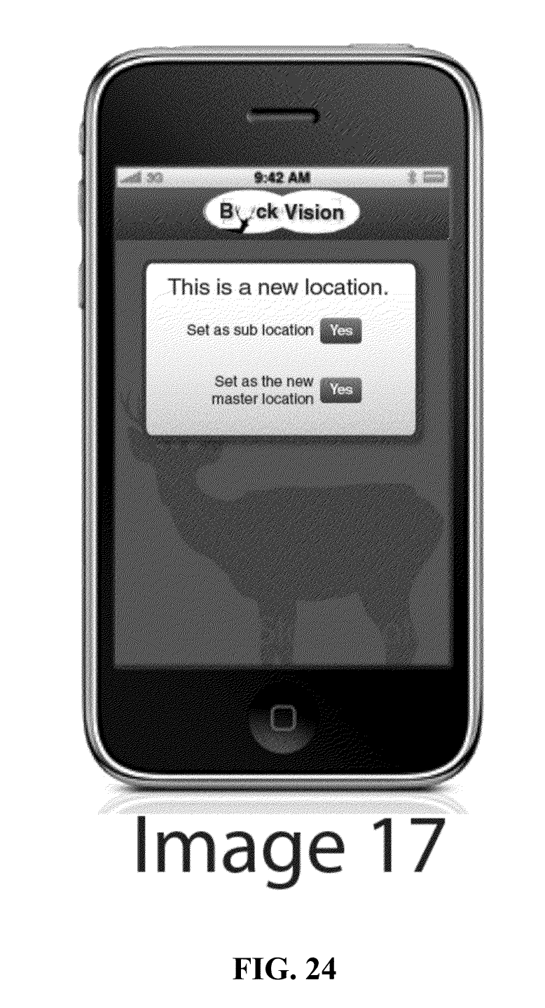

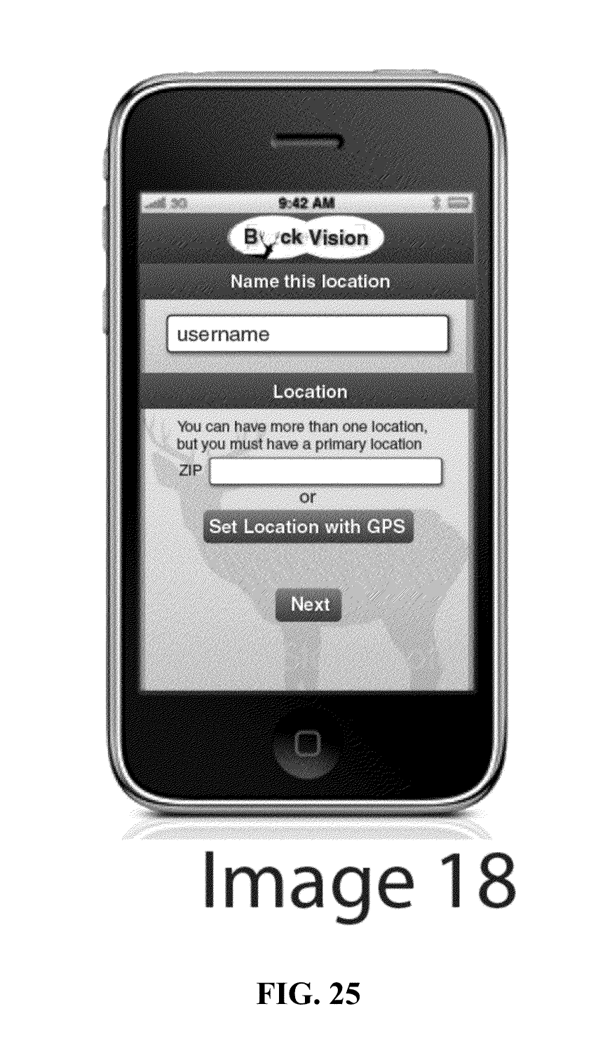

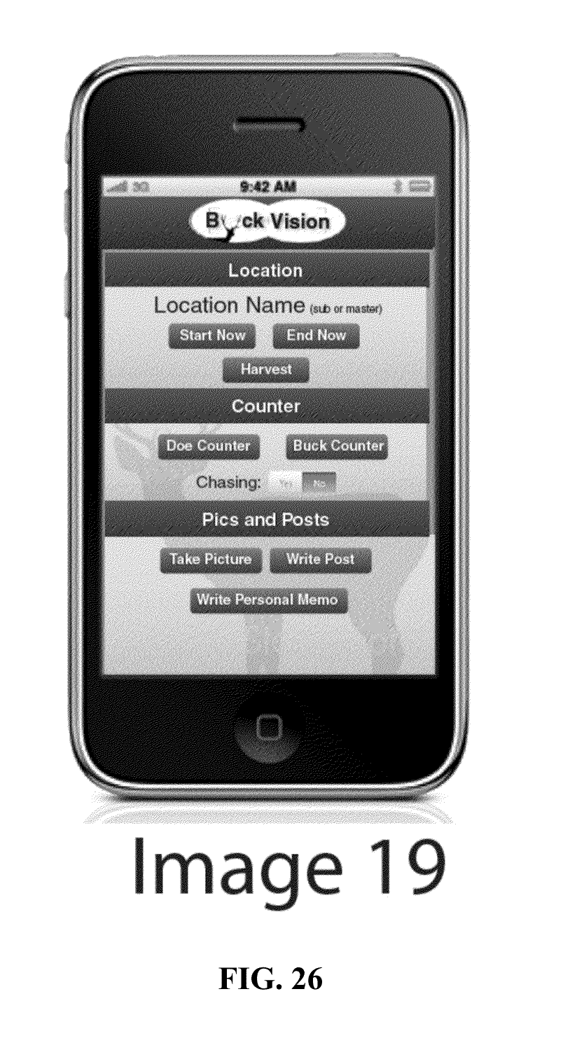

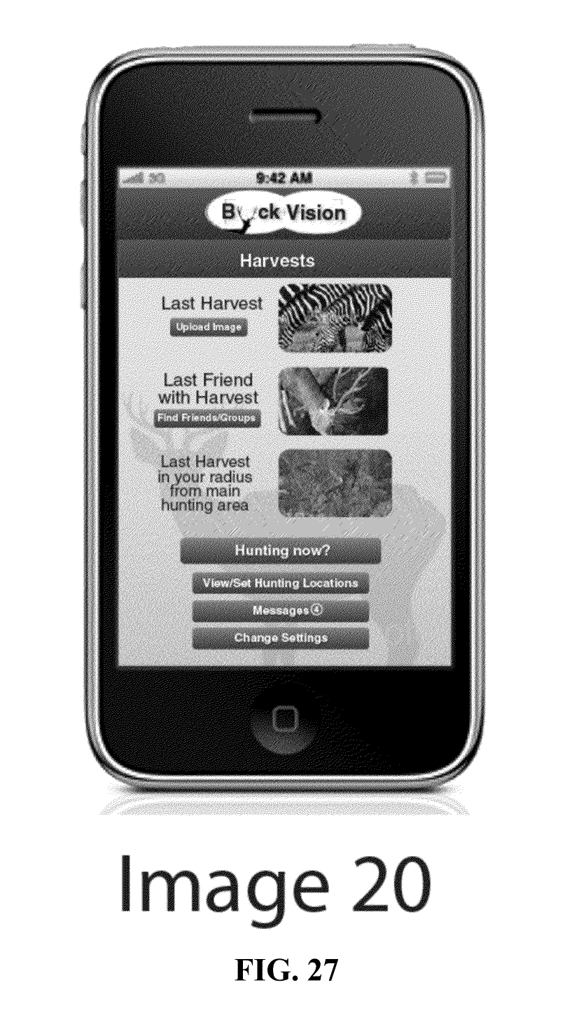

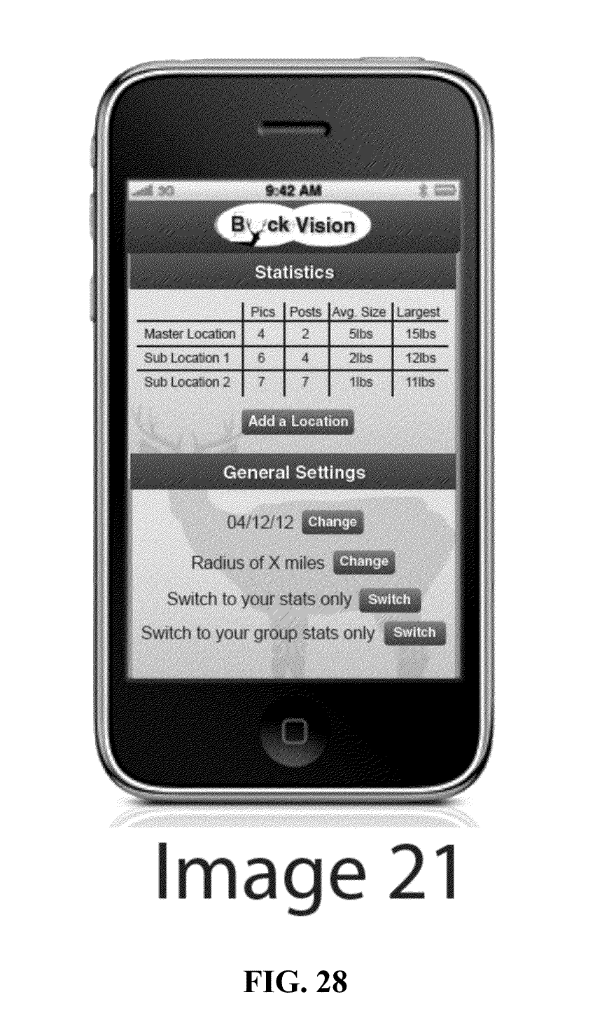

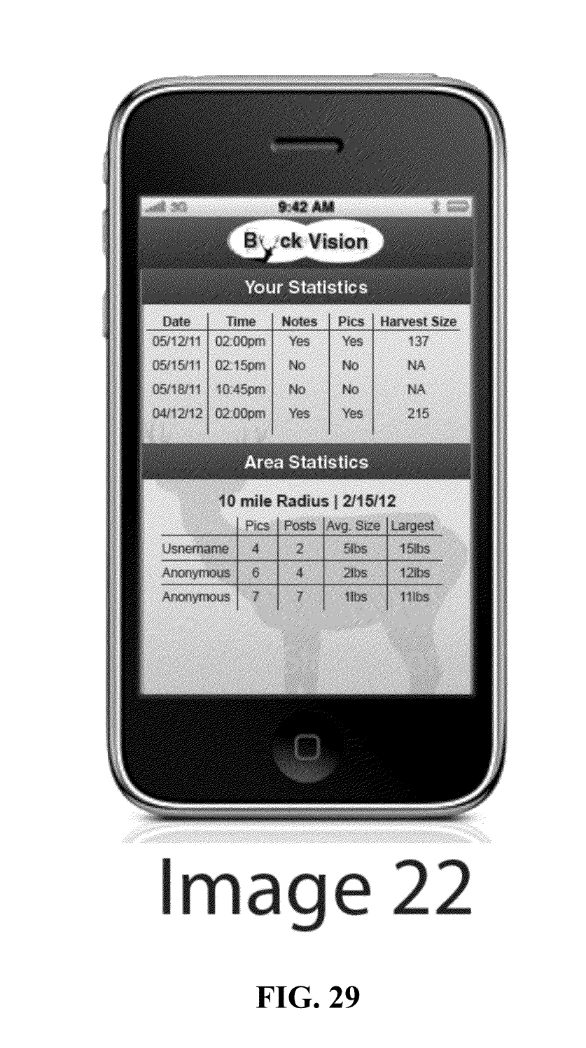

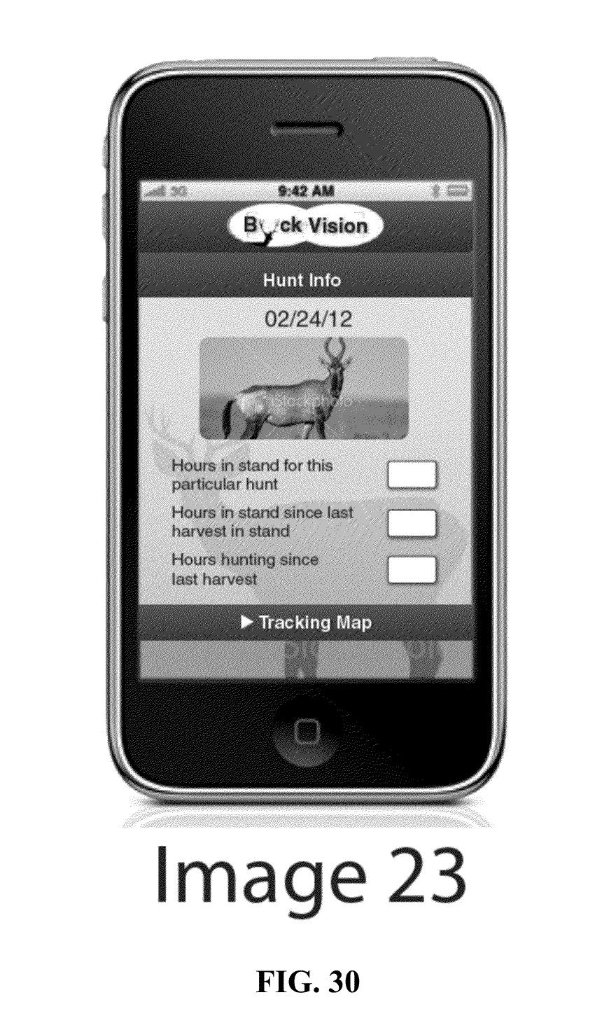

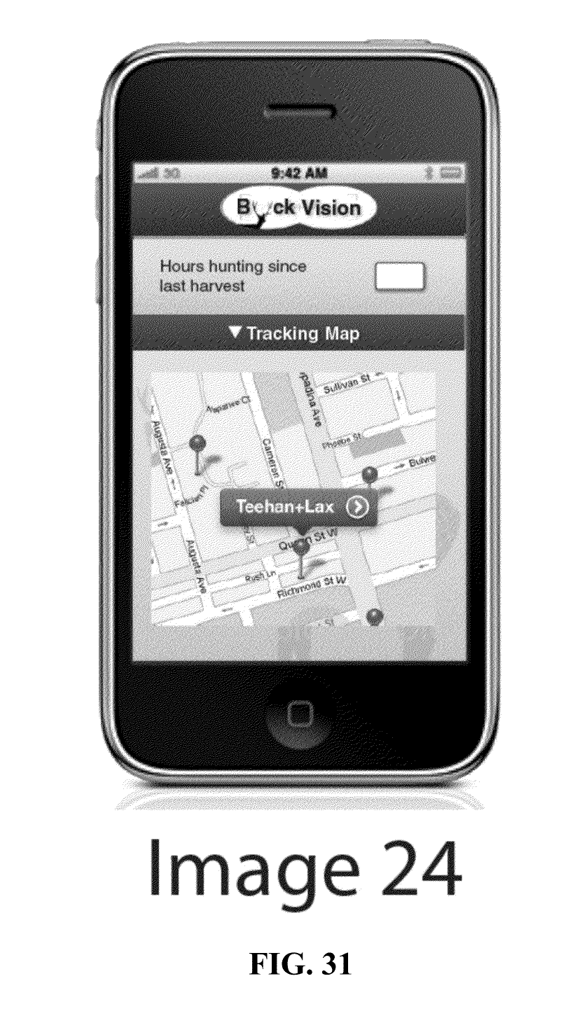

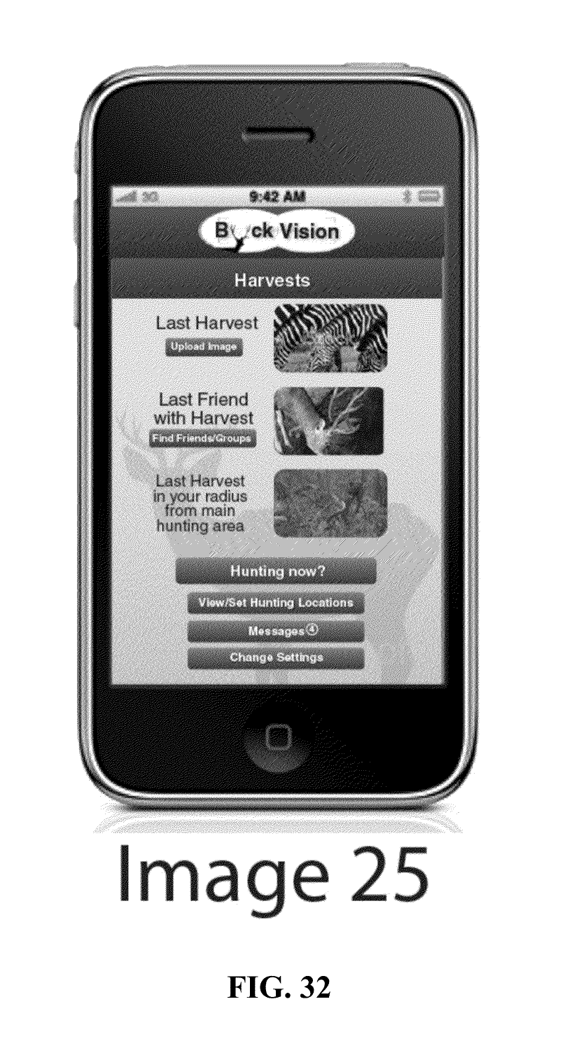

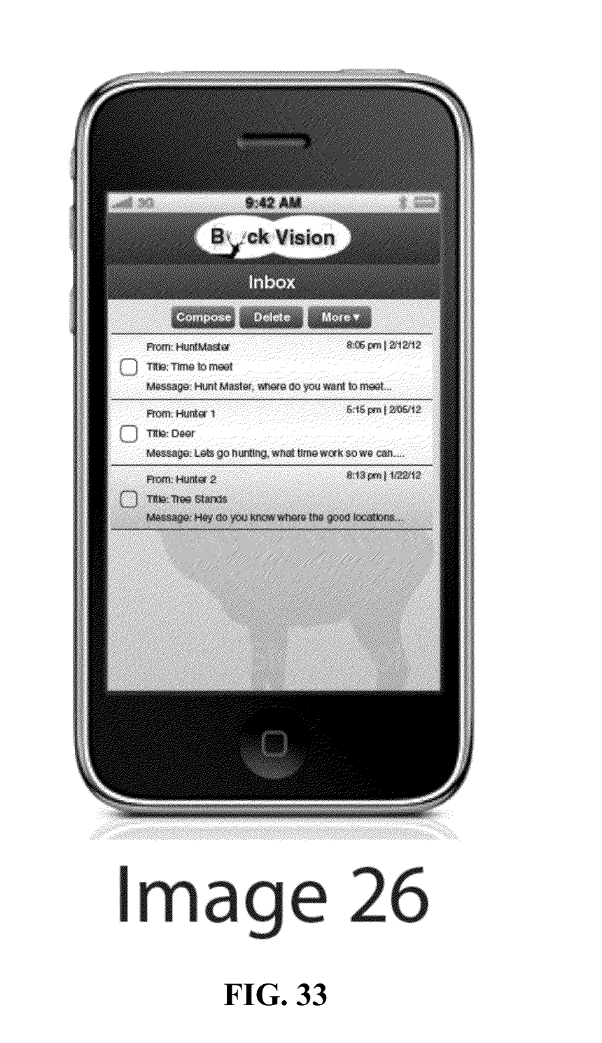

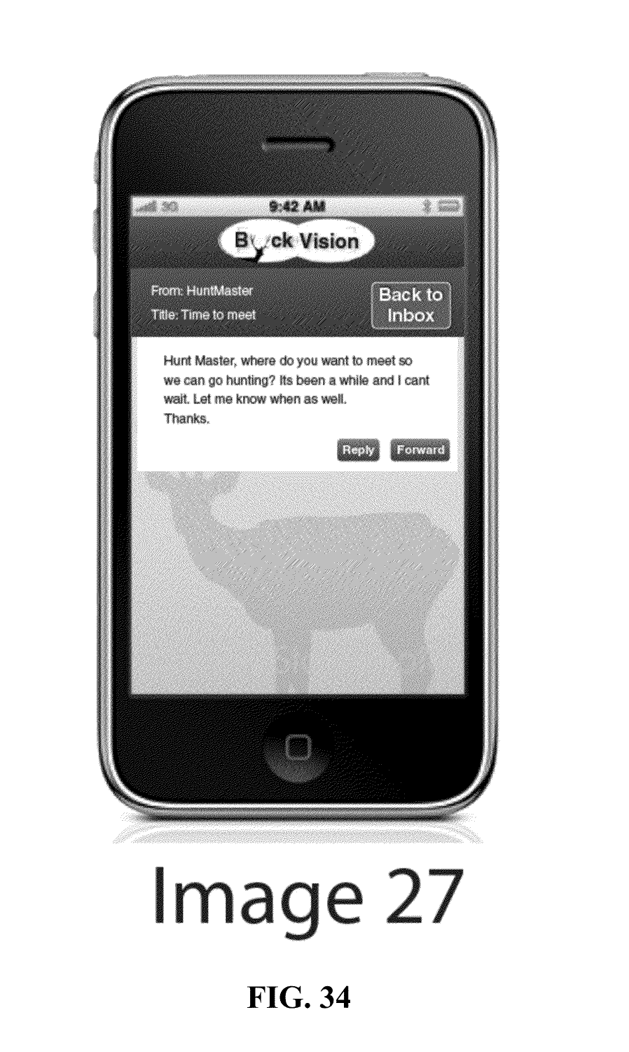

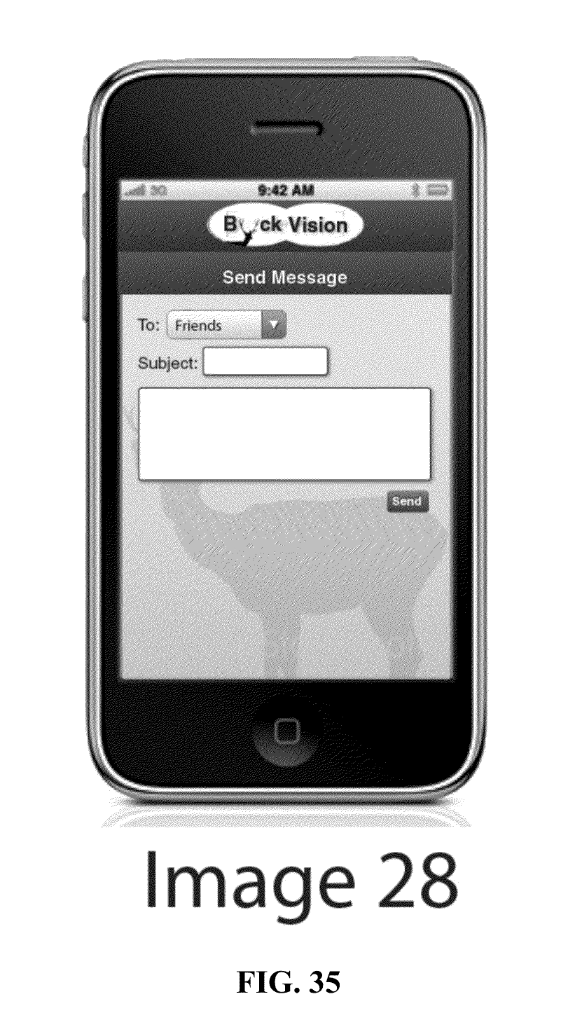

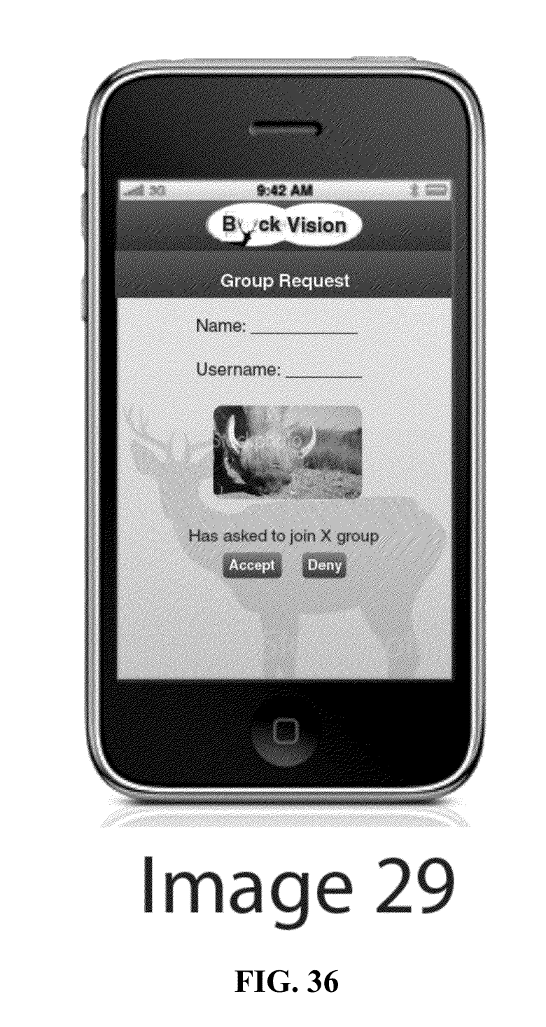

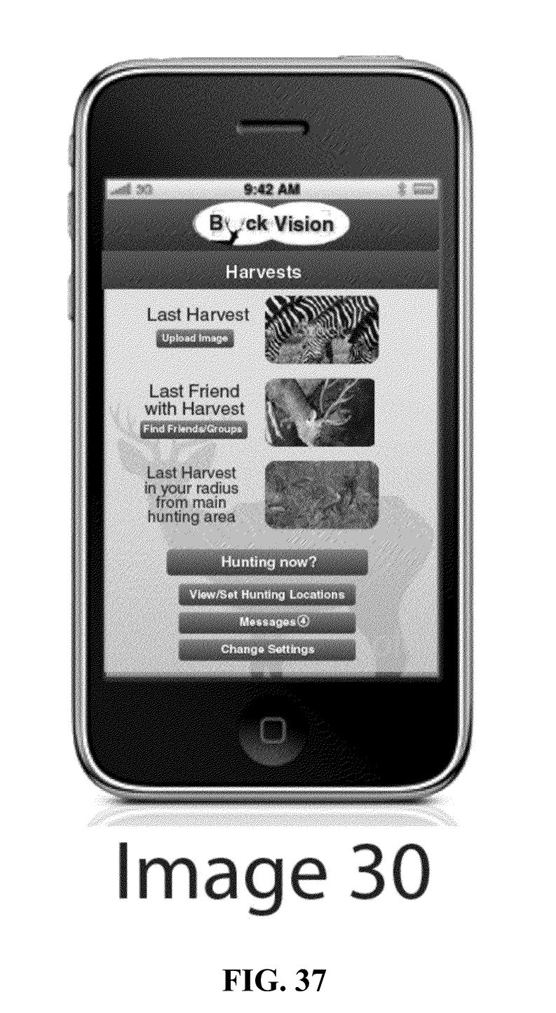

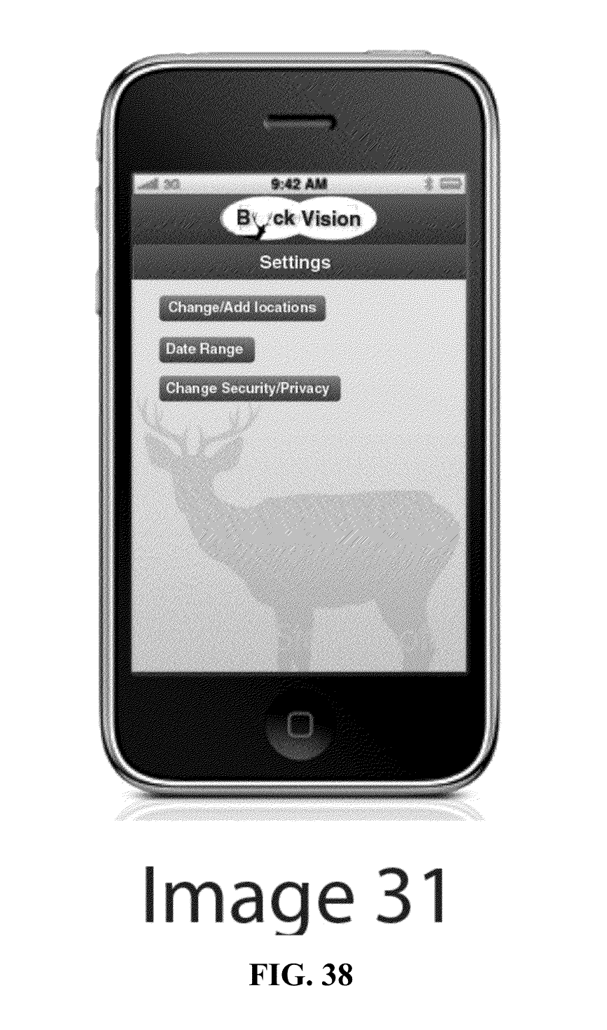

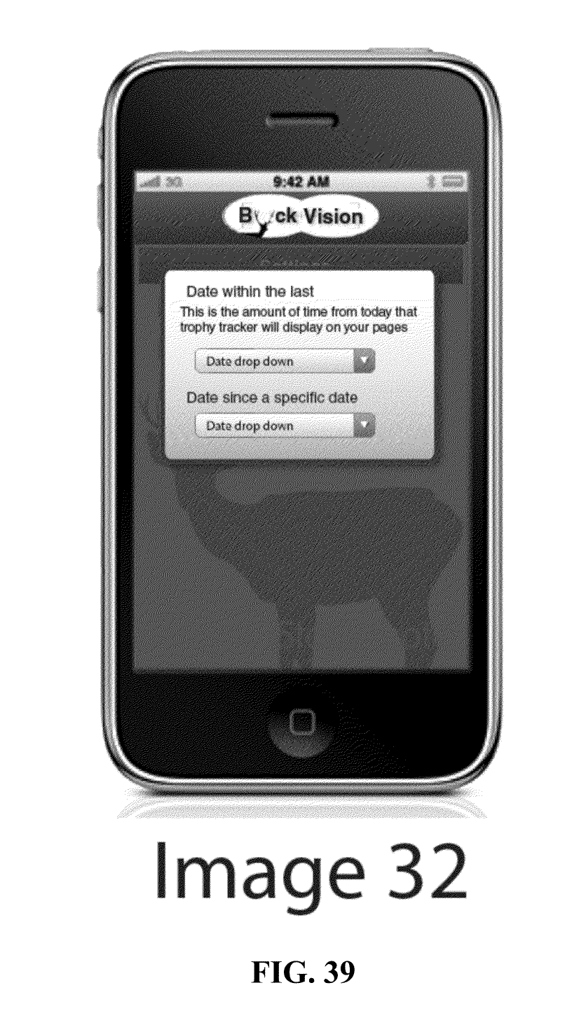

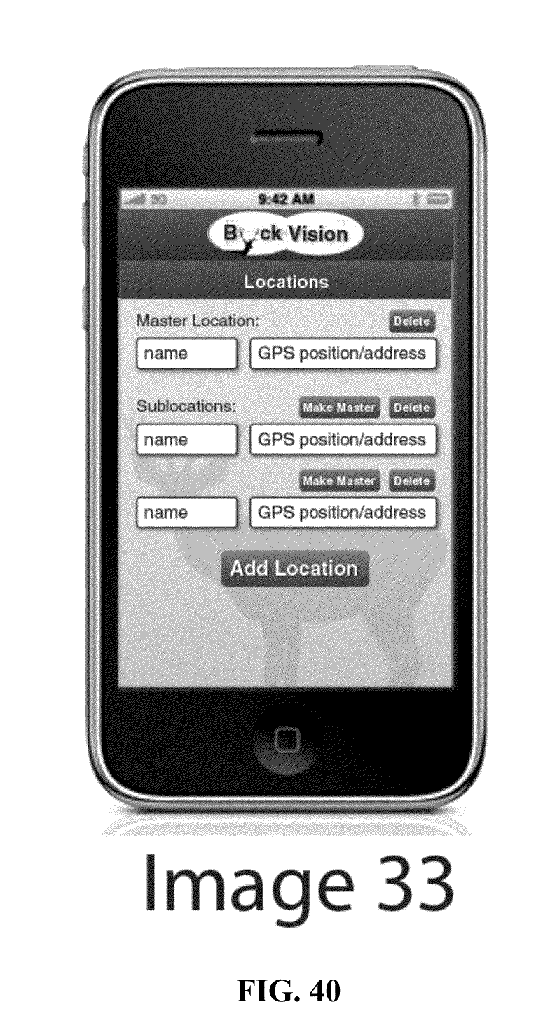

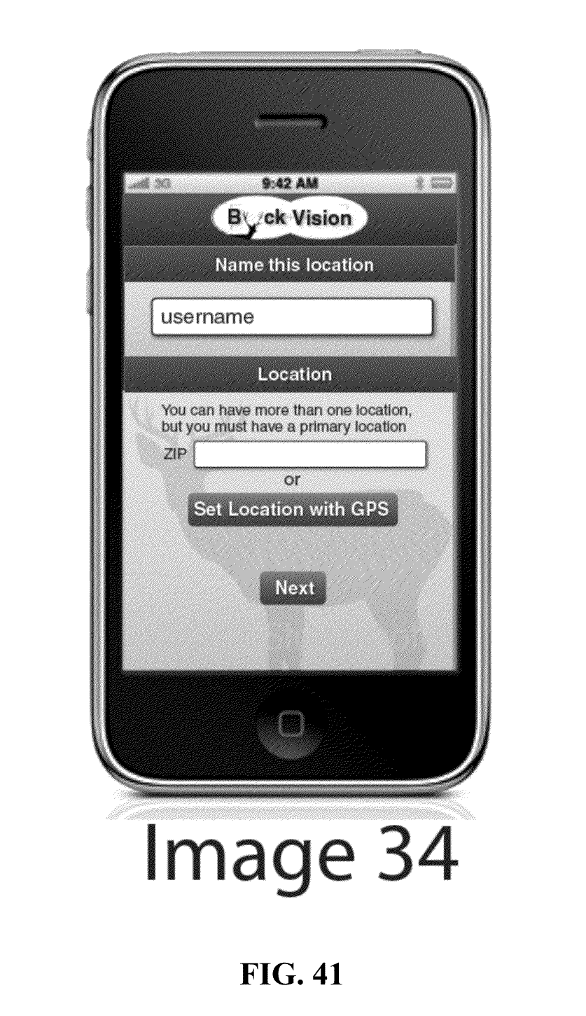

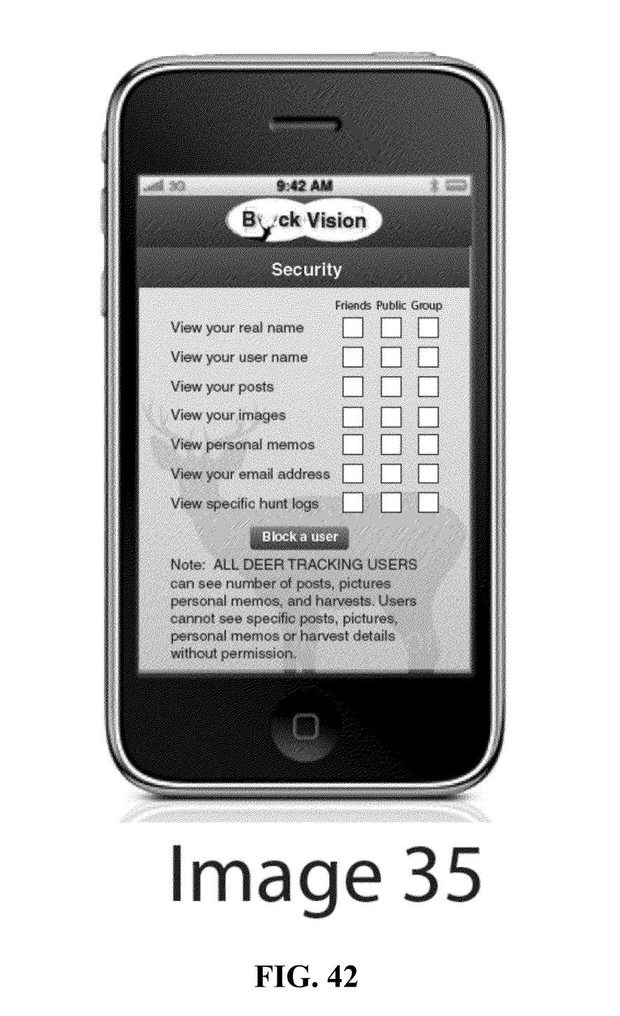

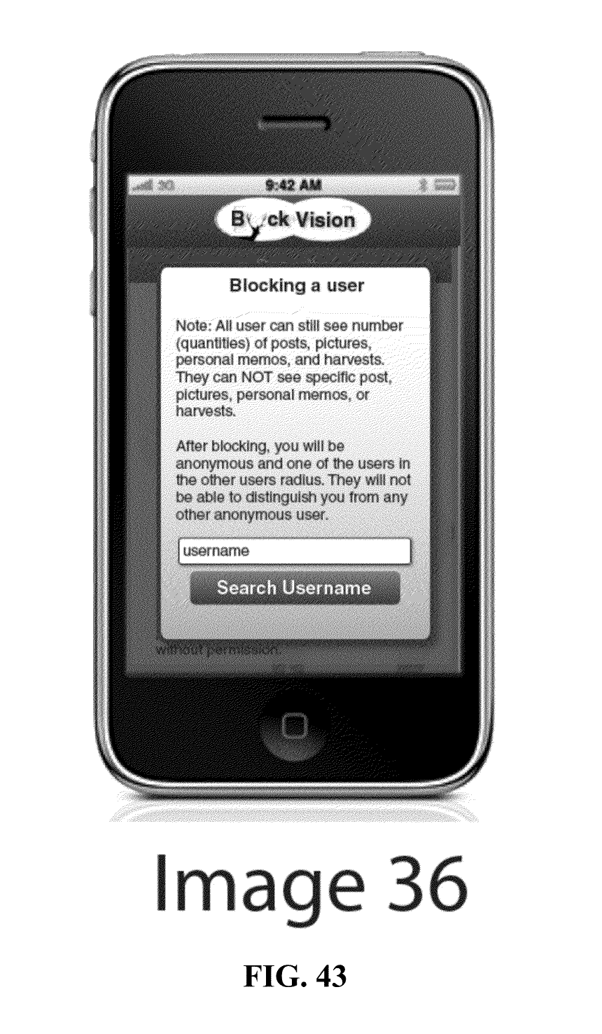

Embodiments of the invention relate to a method and system to share information regarding the timing and/or location of an animal rut. Such embodiments can be used in conjunction with the embodiments of the invention relate to a method and system for allowing a hunter to report a hunting harvest by taking an image of the harvest, where FIG. 3 shows and embodiment where such embodiments are used in conjunction with each other and FIGS. 1 and 2 show embodiments where each is used independently. Embodiments of the invention relate to a social media platform for a group of hunters to use to allow one or more hunters, or spotters, to inform other hunters, or members, of information regarding an animal's rut, such as deer rut. Embodiments of the system allow members to set their smartphones to alert them of when people post messages within a certain distance of their selected location and/or within a certain time period of their selected time period. These alerts can keep hunters better informed of when and/or where rut is occurring, which can allow them to hunt in locations and times that increase their chances of making a harvest.

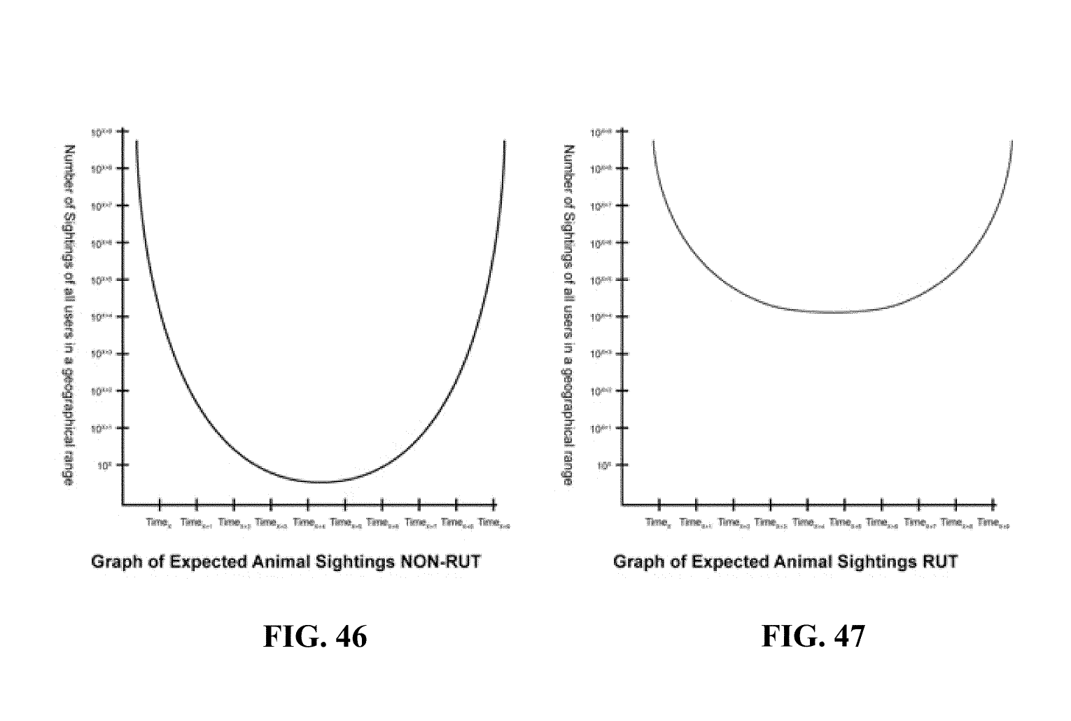

FIG. 2 shows a schematic of an embodiment of a system for inputting, processing, and disseminating information regarding rut for one or more animals, such as deer, in accordance with an embodiment of the subject invention. The notifications list in reference no 16, can also include a phone call, social media post, text message, and other types of messaging. The item marked “A” for rut detection can incorporate the use of data such as from the graphs shown in FIGS. 46 and 47, which can be obtained from available data sources. For example, a determination of rut can be made at the inflection point of the graph of FIG. 46 and/or 47, some period of time surrounding the inflection point or based on some other characteristic of such curve(s).

One feature of a mobile application can allow hunters to upload pictures of deer they see in hunting areas or deer they have harvested 11, giving hunters the ability to post pictures of their harvests. The system can use software, for example, in the cloud or on a dedicate server, to implement an algorithm (and/or data mining) to determine and/or predict when rut is occurring and/or where rut is occurring. The algorithm can take into account the number of pictures being uploaded 12, the locations where the pictures are taken, the nature of any rubbing and/or scraping on trees or brush reported and/or identified in the pictures, and/or other information provided. A message can then be sent out that the rut is occurring 13. In an embodiment, rut is identified when the number of user-reported sightings for a specific area over a specific (and/or specified) time range is over a certain (and/or specified) threshold 13. Aside from notifying the appropriate users of a rut occurrence through the mobile application 16, the information concerning these ruts can also be made available on a website 14. This gives members the ability to see if any ruts are occurring in desired locations and/or their selected location.

Another feature of a specific embodiment is providing the ability for hunters to log information for one or more hunts onto the system 11. Hunters can upload information including, but not limited to, the geographic location, the date, and whether or not there were rut sightings. Again, the software, for example, in the cloud or on a dedicated server, can use an algorithm 12 to determine when the data being processed suggests that a rut is occurring 13. Such data can include when there is a spike in hunting, sightings of rut indicators, and/or other relevant data (such as frequency of doe and/or buck sightings).

An advantage of embodiments of the subject system is that hunters can communicate about the rut and deer population in a more efficient manner than the existing ad hoc methods, which typically involve phone calls, emails, or texts that require the sender and the receiver to know each other. The system can allow hunters to propagate knowledge of the rut (or reports indicating the rut) for a specific geographical location at a specific point in time (or certain time frame) to other hunters 16 who have shown interest in knowing about reports for that geographical location (subscribers) 15, without requiring the subscribing hunters to necessarily know the reporting hunters personally.

Embodiments of the subject system can use crowd sourcing eyewitness reports (the reporting hunters) to identify a rut that is occurring, whereas there is currently no reliable way to identify when a rut is happening. In this way, embodiments of the subject system can utilize human intelligence and eyewitness reports to provide a more reliable method of rut detection. A specific embodiment can also use video and/or still images taken from video cameras and/or still cameras located in hunting areas to be monitored. These videos and/or images can then be monitored by one or more people or by software (such as software incorporating artificial intelligence or other image processing capabilities), where the number of animal movements, the timing of animal movements, rubbings and/or scrapings of trees or bushes, and/or other data can be collected from the videos and/or images, which can then be processed to make determinations or predictions about the location and timing of rut. Specific embodiments can utilize facial recognition software, animal recognition software, software that distinguishes between one or more different animals, and/or other processing capabilities, to provide such determinations.

Regarding determining ruttings, FIGS. 46 and 47, referred to as Rutt-graphscopy, show how data can be mined and used to calculate a rut from, for example, any geographical location. For example, one user may state that they want to define the geographical area as the area within a 50 mile (or 100 mile or 150 mile, etc.) radius from his deer stand or particular geographical region, such as the state he lives in. By taking some, or all, of the aggregate date, a determination of when the sightings of deer spike and/or deer sightings curve shifts up.

Aspects of the invention, such as receiving, processing, and/or sending out information regarding the harvest of an animal, and/or receiving, processing, and/or sending out information regarding the rut of an animal, may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A method of producing and submitting a hunting harvest report to a reporting agency, comprising:
capturing a digital image of a hunting harvest via an image capturing device;
providing the digital image to a mobile computing device;
creating a hunting harvest report via the mobile computing device, wherein the hunting harvest report incorporates at least a portion of the digital image and one or more data regarding the hunting harvest and/or licensed hunter; and
uploading the hunting harvest report to a reporting agency.
